(19) United States
(12) Patent Application Publication
(10) Pub. No.: US 2014/0066299 A1
(43) Pub. Date: Mar. 6, 2014

(54) Particles Containing One Or More Multi-Layered Dots On Their Surface, Their Use, and Preparation of Such Particles

(71) Applicant: BASF SE, Ludwigshafen (DE)

(72) Inventors: Wolfgang Gerlinger, Limburgerhof (DE); Stephan Deuerlein, Ludwigshafen (DE)

(73) Assignee: BASF SE, Ludwigshafen (DE)

(21) Appl. No.: 14/013,560

(22) Filed: Aug. 29, 2013

Related U.S. Application Data
(60) Provisional application No. 61/695,392, filed on Aug. 31, 2012.

(51) Int. Cl. B01J 23/44

(52) U.S. Cl. CPC B01J 23/44
USPC 502/240; 502/300; 502/339

(57) ABSTRACT

Described is a product comprising an amount of particles having one or more multi-layered dots on their surface, each multi-layered dot consisting of two or more layers and having an innermost layer contacting the surface of the particle, and an outermost layer, wherein the innermost layer of the multi-layered dots consists of a first metal and the outermost layer of the multi-layered dots consists of a second metal, different from the first metal.

### CROSS-REFERENCE TO RELATED APPLICATIONS

This application claims the benefit of priority under 35 U.S.C. §119(e) to U.S. Provisional Application No. 61/695,392, filed Aug. 31, 2012, the entire content of which is incorporated herein by reference in its entirety.

### TECHNICAL FIELD

The present invention relates to a supported metal catalyst and methods for producing the support catalyst. Specifically, the invention relates to a supported metal catalyst comprising an amount of particles having one or more multi-layered dot(s) on their surface, and a use of one, two, three, four, or more metal organic precursors for the production of such a product. The invention further relates to a method for producing (a) multi-layered dot(s) onto a substrate, a catalyst system comprising a product comprising an amount of particles having one or more multi-layered dot(s) on their surface, and a use of such a product as a catalyst.

### BACKGROUND

In many industrial catalytic processes, supported metal catalysts lose their activity during operation. This is, in many cases, due (at least partly) to a sintering mechanism. The initially small metal dots on the support agglomerate by various mechanisms to larger dots. This directly relates to a loss of available overall metal surface area. As most metal catalyzed reactions take place at the metal surface, the loss of metal surface area leads to a significant loss of activity in the respective reactions. The sintering is especially pronounced in high-temperature processes and even more so under hydrothermal conditions e.g. in automotive off-gas catalysis. As the catalysts need to be sufficiently reactive at the end of their lifetime (the so-called end-of-run), the activity loss needs to be compensated for by additional metal. This leads to an undesirable rise in resource consumption and to high catalyst prices. Therefore, techniques to reduce the catalyst sintering are highly looked for.

Supported platinum catalysts can be used, for example, in automobiles as catalytic converters (automotive off-gas catalyst), which allow for the complete combustion of remaining low concentrations of unburned hydrocarbons in the exhaust gas mixture into carbon dioxide and water vapor, or other reduction/oxidation reactions such as oxidation of carbon monoxide to carbon dioxide or reduction of nitrogen oxides to nitrogen and oxygen. Platinum is also used in the petroleum industry as a catalyst in a number of separate processes, but especially in catalytic reforming of straight run naphthas into higher-octane gasoline.

Triggered by the ever rising prices of platinum, several ways were found to increase the activity of platinum catalyst and/or to decrease the amount of platinum used for the production of catalyst. One approach is to deposit a particularly thin platinum film on a substrate. Thus, the ratio between the active platinum surface and the used platinum is improved. This ratio can be improved even further, if small platinum dots instead of a continuous platinum film are deposited on the surface of the substrate.

One disadvantage of platinum is that platinum has a tendency to migrate into the substrate (e.g. a particle) on which it is deposited and/or to migrate on the substrate in such a way that several platinum dots fuse (agglomerate) to one bigger platinum dot. These migration processes occur increasingly if the substrate is heated e.g. during a sintering process or during the operation of the substrate (e.g. a particle) whereupon the platinum is deposited as a catalyst (supported platinum catalysts).

A general technique to reduce the sintering of a highly active metal species is to alloy it with one or more other metals. These additional metals are chosen in a way that the resulting alloy has a lesser tendency to migrate, agglomerate, and sinter. The stabilization might e.g. be induced by a stronger interaction of the additional metal(s) with the support, than found for the first metal.

An example for such stabilization is found in automotive off-gas catalysis with its hydrothermal ageing conditions. Under these conditions palladium has a lower tendency to migrate than platinum. By using Pt:Pd alloys the tendency of platinum to migrate can be reduced. It is assumed, that the partially oxidized palladium forms strong interactions to the support (e.g. alumina support) and thereby reduces the mobility of the metal (alloy) dots. This leads to a reduced agglomeration/sintering and thereby reduced deactivation over time. This can clearly be seen in catalytic tests, e.g. comparing a catalyst consisting of 1 wt % Pt on Sasol Puralox TM100/150 as a support with a catalyst containing 1 wt % of a 1:1 molar Pt:Pd mixture on Sasol Puralox™ 100/150 as a support. Test and ageing conditions are given below. In such a setup the aged Pt-catalyst needs an approx. 20° C. higher temperature to reach a CO conversion of 50% compared to the fresh Pt-catalyst. For the Pt:Pd catalyst the difference is only 15° C.

However, compared to the use of pure platinum the catalytic activity of a Pt:Pd alloy is lower. Additionally, as the metals are evenly distributed in the alloy, a lot of the expensive, high-activity metal (Pt in the automotive off-gas case) is buried inside the dot without taking part in the reaction.

### SUMMARY

A first embodiment pertains to a product comprising an amount of particles having one or more multi-layered dots on their surface, each multi-layered dot consisting of two or more layers and having an innermost layer contacting the surface of the particle, and an outermost layer, wherein the innermost layer of the multi-layered dots consists of a first metal and the outermost layer of the multi-layered dots consists of a second metal, different from the first metal.

In a second embodiment, the product of the first embodiment is modified, wherein the particles having one or more multi-layered dots on their surface without consideration of the multi-layered dots have a mean Feret diameter in the range of from 12 to 300 nm.

In a third embodiment, the product of the first and second embodiments is modified, wherein the multi-layered dots have a mean Feret diameter below 10 nm.

In a fourth embodiment, the product of the first through third embodiments is modified, wherein, in processes for depositing metal on the surface of said particles by MOCVD, the first metal has a lower tendency to form larger dots than the second metal.

In a fifth embodiment, the product of the first through fourth embodiments is modified, wherein the second metal has a higher catalytic activity than the first metal, for the reaction of ethane with oxygen to carbondioxide and water.

In a sixth embodiment, the product of the first through fifth embodiments is modified, wherein the first metal is palladium.

In a seventh embodiment, the product of the first through sixth embodiments is modified, wherein the second metal is platinum.

In an eighth embodiment, the product of the first through seventh embodiments is modified, wherein at least 90% of the multi-layered dots having a minimum diameter of 0.1 nm have a diameter in the range of from 0.5 to 4 nm.

In a ninth embodiment, the product of the first through eighth embodiments is modified, wherein the particles have at least 1 multi-layered dot per 100 nm² of the particle surface.

In a tenth embodiment, the product of the first through ninth embodiments is modified, wherein, the particle comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three, or more oxides selected from the group consisting of SiO₂, MgO, Al₂O₃, TiO₂, ZrO₂, Y₂O₃, Cr₂O₃, La₂O₃, Fe₂O₃, ZnO, and SnO.

In an eleventh embodiment, the product of the tenth embodiment is modified, wherein the particle having one or more multi-layered dots on its surface is obtained by a process comprising metal organic chemical vapor deposition of the outer layer on the inner layer.

In a twelfth embodiment, the product of the eleventh embodiment is modified, wherein the substrate having one or more multi-layered dots on its surface is obtained by a metal organic chemical vapor deposition process, wherein a compound of Formula (I)

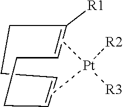

wherein R1 represents a group selected from the list consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene, and wherein R2 and R3 independently of each other are selected from the group consisting of Cl, I, methyl, phenyl, or phenylacetylene, is used as a precursor to form the outer layer of the multi-layered dots.

A second aspect of the invention pertains to a method. In a thirteenth embodiment, a method of producing the product of the first through twelfth embodiments comprises a metal organic chemical vapor deposition process using one, two, three, four, or more metal organic precursors.

In a fourteenth embodiment, the method of the thirteenth embodiment is modified wherein one, two, three, four, or more of the precursors is a compound or are compounds of the general formula (I).

In a fifteenth embodiment, the method of the fourteenth embodiment is modified, wherein the substituents R2 and R3 are identical and each is selected from the group consisting of Cl, I, methyl, phenyl, or phenylacetylene.

In a sixteenth embodiment, the method of the fifteenth embodiment is modified, wherein the compound of the general formula (I) is a compound selected from the group consisting of dichlorido-η⁴-(1Z,5Z)-1-methylcycloocta-1,5-dien)-platinum, diiodido-η⁴-(1Z,5Z)-1-methylcycloocta-1,5-dien)-platinum, dimethyl-η⁴-((1Z,5Z)-1-methylcycloocta-1,5-dien)-platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, η⁴-((1Z,5Z)-1-ethylcycloocta-1,5-dien)diphenyl platinum, dichlorido-η⁴-(1E,5Z)-1-phenylcycloocta-1,5-dien) platinum, diiodido-η⁴-(1E,5Z)-1-phenylcycloocta-1,5-dien) platinum, dimethyl-η⁴-((1E,5Z)-1-phenylcycloocta-1,5-dien) platinum, diphenyl-η⁴-((1E,5Z)-1-phenylcycloocta-1,5-dien) platinum, dichlorido-η⁴-((1E,5Z)-1-isopropylcycloocta-1,5-dien) platinum, diodido-η⁴-((1E,5Z)-1-Isopropylcycloocta-1,5-dien) platinum, η⁴-((1E,5Z)-1-isopropylcycloocta-1,5-dien)dimethyl platinum, and η⁴-((1Z,5Z)-1-isopropylcycloocta-1,5-dien)diphenyl platinum.

In a seventeenth embodiment, the method of the thirteenth through sixteenth embodiments is modified, wherein one, two, three, or more of the precursors are compounds selected from the group consisting of Pd(allyl)₂, Pd(CH₂allyl)₂, Cp(allyl)Pd, [(η³-allyl)(η⁵-cyclopentadienyl)palldium], and Pd(allyl)(hfac).

In an eighteenth embodiment, the method of the thirteenth through seventeenth embodiment is modified, wherein the metal organic chemical vapor deposition process is at least partly or completely performed under a pressure in the range of from 1 mbar to 2000 mbar.

A third aspect of the invention pertains to a method. In a nineteenth embodiment, a method for producing multi-layered dots on a substrate comprises the steps
preparing or providing a substrate having one or more dots on its surface, the dots consisting of an innermost layer of a first metal and, optionally, one or more further layers of metal; and
contacting a precursor with said substrate having one or more dots, under conditions in which the precursor decomposes into a second metal, wherein the second metal is different from the first metal.

In a twentieth embodiment, the method of the nineteenth embodiment is modified, wherein the second metal and the conditions for depositing the second metal on the substrate are selected so that the second metal is predominantly deposited on the dots.

In a twenty-first embodiment, the method of the nineteenth and twentieth embodiments is modified, wherein the precursor for the deposition of the second metal is a compound of formula (I)

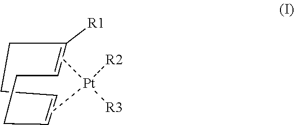

wherein R1 is selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene; and wherein R2 and R3 independently of each other are selected from the group consisting of Cl, I, methyl, phenyl, or phenylacetylene.

Another aspect of the invention pertains to a catalyst system. In a twenty-second embodiment, a catalyst system in a catalytic converter or for asymmetric hydrogenation comprises the product of the first through twelfth embodiments.

### BRIEF DESCRIPTION OF THE DRAWINGS

FIG. 1 is a schematic drawing of an assembly for the continuous generation of particles having multi-layered dots on their surface in the aerosol state by a combined CVS/MOCVD/MOCVD process under atmospheric pressure.

FIG. 2 is as schematic drawing of an assembly for the continuous generation of particles having multi-layered dots on their surface in the aerosol state in a MOCVD process under atmospheric pressure.

FIG. 3 is a schematic drawing of an assembly for the generation of particles having multi-layered dots on their surface in the aerosol state in a MOCVD process under atmospheric pressure.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

Provided is a product containing metal dots on the surface of the substrate, wherein the metal dots have a low tendency to migrate into the surface and/or to migrate on the surface of the substrate in such a way that several dots fuse to one bigger dot.

According to embodiments of a first aspect of the invention, provided is a product comprising or consisting of an amount of particles having one or more multi-layered dots on their surface, each multi-layered dot consisting of two or more layers and having an innermost layer contacting the surface of the particle, and an outermost layer. In one or more embodiments, the innermost layer of the multi-layered dots consists of a first metal and the outermost layer of the multi-layered dots consists of a second metal, different from the first metal.

As used herein, the terms “dots” and “layers” (plural) shall be considered as including a reference to a single dot or layer, respectively. Additionally, dots and layers can refer to more than one (multiple) dots or layers.

In one or more embodiments, the particles having one or more multi-layered dots on their surface without consideration of the multi-layered dots have a mean Feret diameter in the range of from 12 to 300 nm, or in the range of from 25 to 200 nm, or more specifically in the range of from 40 to 100 nm.

In specific embodiments, the multi-layered dots have a mean Feret diameter below 10 nm, or in the range of from 0.2 to 8 nm, or more specifically in the range of from 0.5 to 4 nm.

To identify the “Mean Feret diameter” of an individual particle, a (two-dimensional) TEM photography is prepared. As used herein, the Feret diameter (caliper diameter) is the averaged distance between pairs of parallel tangents to the projected outline of the particle. As used herein, the “Mean Feret diameter” is calculated after consideration of all possible orientations. In one or more embodiments, the Feret diameters for a sufficient number of angles are measured, and their average is calculated.

According to one or more embodiments, a multi-layered dot consists of two or more layers and has at least an innermost layer and an outermost layer. In one or more embodiments, the innermost layer is located between the particle and the outermost layer, but may be separated from the outermost layer by one or more intermediate layers. In some embodiments, the edge area of the outermost layer lies directly on the surface of the substrate (particle).

As used herein, a multi-layered dot is understood to be a metal island (consisting of at least an innermost layer and an outermost layer) on the surface of a particle, the island having a mean Feret diameter of more than 0.1 nm Accumulations of metal(s) having a mean Feret diameter of less than 0.1 nm (e.g. metal atoms on a substrate) are not considered as multi-layered dots. In one or more embodiments, multi-layered dots can be substantially flat (e.g.

ideally the dot can consist of two congruent monolayers (one monolayer of the second metal and one monolayer of the first metal) on the substrate) or can possess a three-dimensional shape, like e.g. a multi-layered dot having a convexity larger than the convexity defined by the underlying substrate surface. In one or more embodiments, provided is a multi-layered dot wherein the outermost layer is not a monolayer. In other embodiments, provided is a multi-layered dot wherein the outermost layer consists of more than five atomic layers. In specific embodiments, provided is a multi-layered dot wherein the outermost layer consists of more than ten atomic layers. In one or more embodiments, to identify the mean Feret diameter of a dot a (two-dimensional) TEM photography is prepared and the mean Feret diameter is determined as described above. In one or more embodiments, to identify the “Average Feret diameter” of an amount of dots a (two-dimensional) TEM photography of an amount of dots is prepared. In one or more embodiments, the “Mean Feret diameter” for each individual dot in the TEM photography is determined, and their average is calculated.

According to one or more embodiments, the first metal acts to decrease the tendency of the second metal to form larger dots. This can be determined by comparing the sintering behavior of supported dots of the second metal to the sintering behavior of supported dots of an 1:1 (molar) alloy of the first and the second metal. The supported pure metal and alloy dots can be prepared by means known to the person skilled in the art, e.g. by incipient wetness impregnation of the support with decomposable metal salts (e.g. metal nitrates) and subsequent drying and calcination. The material for the support particles should be chosen according to the support used in the actual catalytic reaction where the product of the present invention will be used. If this cannot be defined clearly, gamma-alumina (e.g. Sasol Puralox TM100/150) shall be used as support. In one or more embodiments, the “Average Feret diameter” of the freshly prepared dots is chosen to be in the range of 0.5 to 2 nm. In one or more embodiments, the sizes of the freshly prepared dots on the support must be similar for the product containing only the second metal and the product containing the alloy. In other words, the “Average Feret diameter” for the dots present in the two samples shall be equal within +/−1 nm The “Average Feret diameter” of the dots present in the two samples is then recorded for later use. Then the samples are aged at 750° C. in an atmosphere of 20% water in air for 20 h. After ageing, the “Average Feret diameter” of the dots present in the two samples is again recorded. The “Dot Growth” is calculated as a ratio of “Average Feret diameter” after ageing to initial “Average Feret diameter.” In one or more embodiments, an alloy is classified as stabilized if its “Dot Growth” is at least 5% (relative) lower compared to the “Dot Growth” of the pure second metal (set to be 100%). Consequently, the first metal is then also classified as stabilizing the second metal.

According to one or more embodiments, the second metal has a higher catalytic activity than the first metal, for the intended catalytic application. In other embodiments, the second metal has a higher catalytic activity than the first metal, for the oxidation of CO to CO₂ in an automotive off-gas test reaction. In this case the catalytic test (automotive off-gas test reaction) is conducted in a tubular reactor by recording the necessary temperature for a CO conversion of 50% (so-called T₅₀). A lower T₅₀ equals a higher catalyst activity. For the test, 200 mg of catalyst powder which has been compacted and split to obtain a 300-700 μm fraction is used. The catalyst is exposed to a gas mixture of 1,500 ppm CO in 3 vol % O₂, 10 vol % CO₂, 5 vol % H₂O, balance N₂ at 1.2 bar(abs) at a GHSV (gas-hourly-space-velocity) of 30,000 NL_{gas}/(L_{cat}.h)—with NL being the gas volume in liters at standard temperature and pressure (1,013 mbar, 273,15° C.). To obtain steady state results, the catalyst is kept in this gas flow at 250° C. for 2 h before measuring its activity. Afterwards the T₅₀ is recorded. The CO level present in the inlet and outlet gas of the reactor is determined by GC-WLD or IR spectroscopy, preferably GC-WLD. A metal is classified as more active than the other if its T₅₀ is at least 2° C. lower.

According to one or more embodiments, the first metal and/or the second metal is selected from the group consisting of platinum, palladium, rhodium, iridium, gold, silver, nickel, cobalt, and zinc.

In one or more embodiments, the first metal is selected from the group consisting of platinum, palladium, rhodium, iridium, gold, and silver.

In one or more embodiments, the second metal is selected from the group consisting of gold, silver, nickel, cobalt, and zinc.

In one or more embodiments, the metals are selected so that the first metal acts to decrease the tendency of the second metal to form larger dots and/or wherein the second metal has a higher catalytic activity than the first metal (as to catalytic activity see above).

In one or more embodiments, platinum has a high catalytic activity and palladium has a low tendency to migrate into the surface and/or to migrate on the surface of the particle in such a way that several dots fuse to one bigger dot.

In specific embodiments, the first metal is palladium and/or the second metal is platinum.

In one or more embodiments, at least 90% of those multi-layered dot(s) having a minimum mean Feret diameter of 0.1 nm have a mean Feret diameter diameter in the range of from 0.5 to 4 nm Surprisingly, when using compounds, as described below, of the present invention in a method, as described below, of the present invention method, parameters can readily be identified resulting in such narrow dot diameter distribution.

In one or more embodiments, at least 90% of the multi-layered dots have a mean Feret diameter in the range of from 70% to 130%, specifically in the range from 80% to 120%, more specifically in the range of from 90% to 110%, of the average Feret diameter of the multi-layered dots.

According to one or more embodiments, the particles have at least 1 multi-layered dot per 100 nm² of the particle surface. In other embodiments, the particles have at least 4 multi-layered dots per 100 nm² of the particle surface. In specific embodiments, the particles have at least 6 multi-layered dots per 100 nm² of the particle surface.

To identify the number of dots per 100 nm² a (two-dimensional) TEM photography of an individual particle is prepared and the multi-layered dots in an area of 100 nm² are counted.

As used herein, the particles on which the multi-layered dots are located are also understood to be substrate or support.

According to one or more embodiments, an abundance of materials may be used as a substrate (particles), also called support (particles). In one or more embodiments, it has been shown that some substrate materials have particularly good properties. Thus, in one or more embodiments, the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three, or more oxides selected from the group consisting of SiO₂, MgO, Al₂O₃, TiO₂, ZrO₂, Y₂O₃, Cr₂O₃, La₂O₃, Fe₂O₃, ZnO, and SnO.

In one or more embodiments, the substrate comprises particles selected from the group consisting of cylindrical, discoidal, tabular, ellipsoidal, equant, irregular, and spherical particles. In specific embodiments, the substrate comprises spherical particles.

As used herein, particular particles with a sphericity of more than 0.9 are considered to be spherical particles. As used herein, the “sphericity” is the ratio of the perimeter of the equivalent circle (circle that has the same area as the projection area of the particle) to the real perimeter of the projection of the particle. The sphericity result is a value between 0 and 1. The smaller the value, the more irregular the shape of the particle because an irregular shape causes an increase in the real perimeter. The ratio is always based on the perimeter of the equivalent circle because this is the smallest possible perimeter with a given projection area. To identify the sphericity of a particle a (two-dimensional) TEM photography of the particle is prepared.

In one or more embodiments, products of the present invention are prepared by or preparable by using a metal organic chemical vapor deposition process. When corresponding products of the invention are carefully analyzed, traces of the metal organic precursors can be detected so that products according to the invention can be distinguished from other products.

The CVD (chemical vapor deposition) process is known as a coating method. It is among the most important processes in thin film technology. The CVD process is mainly used in the production of functional materials such as optical waveguides, insulators, semiconductors, conductor strips and layers of hard materials. In this process, molecular precursors transported in the gas phase react on hot surfaces in the reactor to form adherent coatings. Gas phase methods derived from metal organic chemical vapor deposition (MOCVD) have been used for the synthesis of catalysts, and show certain advantages since interfering salts and stabilizers are not present.

Overviews of the principle and applications of the CVD technique may be found, for example, in the following references: A. Fischer, Chemie in unserer Zeit 1995, 29, No. 3, pp. 141-152; Weber, Spektrum der Wissenschaft, April 1996, 86-90; L. Hitchman, K. F. Jensen, Acad. Press, New York, 1993 and M. J. Hampden-smith, T. T. Kodas, The Chemistry of Metal CVD, VCH, Weinheim, 1994, which are herein incorporated by reference in their entireties.

The principle of MOCVD is that of vaporizing a volatile precursor of the metal, namely an organometallic complex, which decomposes thermally on the substrate to form a metallic layer. In practice, the vaporization takes place under pressure and temperature conditions that make it possible to obtain a sufficient precursor vapor pressure for the deposit, while, at the same time, the precursor remains within its stability range. As regards the substrate, it is heated beyond this stability range, which allows decomposition of the organometallic complex and the formation of metal particles. The MOCVD method has various advantages over other known methods: the thermolysis temperature in MOCVD is typically 1000 to 2000 K lower than for other vapor deposition techniques not using organometallic complexes. The films obtained with MOCVD are dense and usually continuous. For example, in contrast with liquid impregnation methods, MOCVD is rapid, and impregnation, washing, drying, purification, and activation steps are avoided. Poisoning of the surface of the deposited layer, and modifications of the product during drying are also avoided. MOCVD is thus a controllable, rapid and economical method for obtaining high quality metal layers on a substrate.

Various organometallic platinum compounds, i.e. complexes containing platinum and organic ligands, are currently widely used. Examples include, but are not limited to, Pt(acac)₂, Pt(PF₃)₄, (COD)PtMe₂, MeCpPtMe₃, and EtCpPtMe₃.

JP 08-157490 A discloses the use of diethyl-η⁴-(1,5-dimethylcycloocta-1,5-dien) platinum and diethyl-η⁴-(1,6-dimethylcycloocta-1,5-dien) platinum as precursors for use in the metal organic chemical vapor deposition method (MOCVD method). The organometallic precursors are used for the formation of thin platinum films which are useful as an electrode for dielectric memories of a semiconductor device. The 1,5-cyclooctadien ligand of the described compounds contains two substituents and therefore the precursor possesses a high symmetry.

JP 10-018036 A discloses the use of diethyl-η⁴-(1,5-dimethylcycloocta-1,5-dien) platinum and diethyl-η⁴-(1,6-dimethylcycloocta-1,5-dien) platinum as a precursor for the metal organic chemical vapor deposition method (MOCVD method). The precursors are dissolved in an organic solvent and the solution is used in the MOCVD process. The precursors are used for the formation of thin platinum films which can be used for contacts, wiring, etc. of semiconductor devices.

U.S. 2011/0294672 A1 and WO 2010/081959 A2 disclose the use of platinum precursors with norbornadiene or norbornadiene derivatives being used as a ligand (e.g. dimethyl-η⁴-(7-methyl-norbornadiene) platinum or dimethyl-η⁴-norbornadiene platinum). The described precursors are used in a metal organic chemical vapor deposition process (MOCVD process) for the manufacture of a platinum film or dispersion. The films can be used in electronic devices or as catalysts.

WO 03/106734 A2 discloses the use of bis-(perfluoropropyl)-1,5-cyclooctadiene platinum as photosensitive organometallic compounds which are used in the production of metal deposits. Using the described compounds, substantially continuous thin ‘sheet-like’ films or substantially narrow lines can be obtained, which possess electrical conductivity.

The synthesis of silica particles by chemical vapor synthesis and the deposition of palladium dots on such silica particles by metal organic chemical vapor deposition (MOCVD) is described, for example, in the following references: Axel Binder et al. Chem. Vap. Deposition 2007, 13, 48-54; Axel Binder et al. Chem. Vap. Deposition 2011, 17, 54-57, and Axel Binder et al. J. Phys. Chem. C 2010, 114, 7816-7821, which are herein incorporated by reference in their entireties.

The possibility of forming a satisfactory metallic deposit via the MOCVD method depends on the volatility of the organometallic (precursor) compound. Specifically, MOCVD requires the possibility of obtaining both a high vapor pressure and high stability of the precursor compound. An organometallic (precursor) compound for use in the MOCVD process
should have a good volatility,
a good thermal stability during its evaporation and transport in the gas phase,
a high purity (or it should be readily purifyable),
it should decompose cleanly on pyrolysis without contamination of the growing film (e.g. by carbon),
it should be non-toxic, non-pyrophoric, not-corrosive
readily available in consistent quality and quantities at low cost, and
it should be stable in its container over a long period.

One particularly interesting application of organometallic precursors (organometallic platinum compound) is the preparation of platinum catalysts by metal organic chemical vapor deposition.

According to one or more embodiments, the particle having one or more multi-layered dots on its surface is obtained by a process comprising metal organic chemical vapor deposition of the outer layer on the inner layer.

In one or more embodiments, these products are characterized by the fact that the multi-layered dots have usually a narrow size distribution and have usually fewer impurities than products produced by wet chemical processes.

In one or more embodiments, products of the present invention are prepared by or preparable by a method of the present invention as discussed below. When corresponding products of the invention are carefully analyzed, traces of compounds of formula (I), as described below, can be detected so that products prepared by a method of the present invention can be distinguished from other products.

In one or more embodiments, the substrate having one or more multi-layered dots on its surface is obtained by a metal organic chemical vapor deposition process, wherein a compound of formula (I), as defined below, is used as precursor to form the outer layer of the multi-layered dots and/or the metal organic chemical vapor deposition process is performed according to a method as described below.

In one or more embodiments, the substrate having one or more multi-layered dots on its surface is obtained by a polyol method.

The polyol method is known to the person skilled in the art and is described, for example, in the following reference: Viau et al. J. Mater. Chem. 1996, 6, 1047, which is herein incorporated by reference in its entirety. In addition to the described reducing agents, also alcohols (e.g. ethanol or n-Butanol) or reducing agents like ascorbic acid or lithium aluminium hydride can be used. As stabilizers, compounds can be used which are known to stabilize metal particles under the used condition, especially coordinating polymers (e.g. polyvinylpyrrolidone, PVP).

In one or more embodiment, the product of the present invention comprises or consists of an amount of spherical particles having one or more multi-layered dots on their surface, each multi-layered dot consisting of two layers and having an innermost layer contacting the surface of the particle, and an outermost layer,

wherein the innermost layer of the multi-layered dots consists of palladium and the outermost layer of the multi-layered dots consists of platinum, and

wherein the multi-layered dots have a mean Feret diameter in the range of from 0.5 to 4 nm.

In specific embodiments, the product according to the present invention comprises or consists of an amount of spherical particles having one or more multi-layered dots on their surface, each multi-layered dot consisting of two layers and having an innermost layer contacting the surface of the particle, and an outermost layer,

wherein the innermost layer of the multi-layered dots consists of palladium and the outermost layer of the multi-layered dots consists of platinum,

wherein the spherical particles having one or more multi-layered dots on their surface without consideration of the multi-layered dots have a mean Feret diameter in the range of from 40 to 100 nm, and

wherein the multi-layered dots have a mean Feret diameter in the range of from 0.5 to 4 nm

Without intending to be bound by theory, it is believed that a metal organic chemical vapor deposition process (MOCVD process) for producing the outer layer of a multi-layered dot onto a substrate consists of the following steps:
Transfer of the used precursor (e.g. compound of the present invention) into a carrier gas stream, usually by sublimation of the precursor
Transport of the precursor to the substrate
Adsorption of the precursor and/or chemisorption of the precursor on functional groups (e.g. hydroxyl, carbonyl or amino groups) on the surface of the substrate or on the surface of the dot on the substrate, wherein the dot represents the inner layer of the multi-layered dot
Cleavage of the volatile ligands from the precursor, and release of the second metal from the precursor,
Desorption of the ligands from the surface of the substrate

Structural growth and/or layer growth by surface diffusion of the second metal on the dot and/or autocatalysis so that the second metal is finally deposited onto the dot (inner layer of the multi-layered dot) and a multi-layered dot is formed.

Without intending to be bound by theory, it is believed that the first metal on the surface of the substrate (inner layer of the multi-layered dot) is catalytically active and catalyzes the decomposition and coating process of the second metal, leading to the formation of a multi-layered dot.

Embodiments of an additional aspect of the present invention relate to the use of one, two, three, four, or more metal organic precursors for the production of a product according to the invention.

Surprisingly, when using metal organic precursors for the production of a product according to the invention as defined above, method parameters can easily be identified resulting in such multi-layered dots on a substrate as described above.

In one or more embodiments, one, two, three, four, or more of the precursors is a compound selected from the group consisting of Pt(NO₃)₂, (NH₃)₄Pt(NO₃)₂, H₂PtCl₆, H₂Pt(OH)₆, Pt(acac)₂, Pt(OAc)₂, Pt(PF₃)₄, (COD)PtMe₂, MeCpPtMe₃, and EtCpPtMe₃.

In one or more embodiments, one, two, three, four, or more of the precursors is a compound or are compounds of the general formula (I)

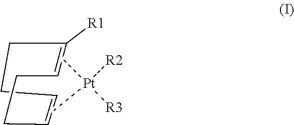

wherein

R1 is selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene; and wherein

R2 and R3 independently of each other are selected from the group consisting of Cl, I, methyl, phenyl, or phenylacetylene.

In one or more embodiments, the use of compounds of the formula (I) for the production of a product according to the invention leads to multi-layered dots with a narrow size distribution.

In one or more embodiments, the substituents R2 and R3 are identical and each is selected from the group consisting of Cl, I, methyl, phenyl, or phenylacetylene.

In specific embodiments, the compound of the general formula (I) is a compound selected from the group consisting of
dichlorido-η⁴-(1Z,5Z)-1-methylcycloocta-1,5-dien) platinum,
diiodido-η⁴-(1Z,5Z)-1-methylcycloocta-1,5-dien) platinum,
dimethyl-η⁴-((1Z,5Z)-1-methylcycloocta-1,5-dien) platinum,
η⁴-((1Z,5Z)-1-methylcycloocta-1,5-dien)diphenyl platinum,
dichlorido-η⁴-(1Z,5Z)-1-ethylcycloocta-1,5-dien) platinum,
η⁴-((1Z,5Z)-1-ethylcycloocta-1,5-dien)diiodido platinum,
η⁴-((1Z,5Z)-1-ethylcycloocta-1,5-dien)dimethyl platinum,
η⁴-((1Z,5Z)-1-ethylcycloocta-1,5-dien)diphenyl platinum,
dichlorido-η⁴-((1E,5Z)-1-phenylcycloocta-1,5-dien) platinum,
diiodido-η⁴-((1E,5Z)-1-phenylcycloocta-1,5-dien) platinum,
dimethyl-η⁴-((1E,5Z)-1-phenylcycloocta-1,5-dien) platinum,
diphenyl-η⁴-((1E,5Z)-1-phenylcycloocta-1,5-dien) platinum,
dichlorido-η⁴-((1E,5Z)-1-isopropylcycloocta-1,5-dien) platinum,
diiodido-η⁴-((1E,5Z)-1-Isopropylcycloocta-1,5-dien) platinum,
η⁴-((1E,5Z)-1-isopropylcycloocta-1,5-dien)dimethyl platinum,
η⁴-((1Z,5Z)-1-isopropylcycloocta-1,5-dien)diphenyl platinum,
dichlorido-η⁴-((1E,5Z)-1-n-butylcycloocta-1,5-dien) platinum,
diiodido-η⁴-((1E,5Z)-1-n-butylcycloocta-1,5-dien) platinum,
dimethyl-η⁴-((1E,5Z)-1-n-butylcycloocta-1,5-dien) platinum,
diphenyl-η⁴-((1E,5Z)-1-n-butylcycloocta-1,5-dien) platinum,
dichlorido-η⁴-((1E,5Z)-1-iso-butylcycloocta-1,5-dien) platinum,
diiodido-η⁴-((1E,5Z)-1-iso-butylcycloocta-1,5-dien) platinum,
dimethyl-η⁴-((1E,5Z)-1-iso-butylcycloocta-1,5-dien) platinum,
diphenyl-η⁴-((1E,5Z)-1-iso-butylcycloocta-1,5-dien) platinum,
dichlorido-η⁴-((1E,5Z)-1-n-hexylcycloocta-1,5-diene) platinum,
diiodido-η⁴-((1E,5Z)-1-n-hexylcycloocta-1,5-diene) platinum, and
η⁴-((1E,5Z)-1-n-hexylcycloocta-1,5-diene)dimethylplatinum preferably preferred selected from the group consisting of
dimethyl-η⁴-((1E,5Z)-1-n-butylcycloocta-1,5-dien) platinum,
dimethyl-η⁴-((1E,5Z)-1-iso-butylcycloocta-1,5-dien) platinum,
η⁴-((1E,5Z)-1-n-hexylcycloocta-1,5-diene)dimethylplatinum, and
dimethyl-η⁴-((1Z,5Z)-1-ethylcycloocta-1,5-dien)-platinum.

According to one or more embodiments, the compound of formula (I) is particularly suitable for the production of a product according to the invention, wherein the compound of formula (I) is used for the production of the outer layer of the multi-layered dot.

In one or more embodiments, one, two, three, or more of the precursors is a compound selected from the group consisting of Pd(OAc)₂, Pd(NO₃)₂, (NH₃)₄Pd(NO₃)₂, Pd(acac)₂, PdCl₂, Pd(allyl)₂, Pd (CH₂allyl)₂, Cp(allyl)Pd [(η³-allyl)(η⁵-cyclopentadienyl)palladium], and Pd(allyl)(hfac).

Due to the high volatility and high stability of the precursors as described above, especially of the compound of formula (I) of the present invention, in one or more embodiments, it is possible to use these precursors in MOCVD processes performed under atmospheric pressure. In one or more embodiments, the metal organic chemical vapor deposition process is at least partly or completely performed under a pressure in the range of from 1 mbar to 2000 mbar, specifically in the range of from 500 mbar to 1500 mbar, more specifically in the range of from 900 mbar to 1200 mbar.

In one or more embodiments, the metal organic chemical vapor deposition process is performed in a continuous gas-phase or in a fluidized bed.

In one or more embodiments, the present invention employs compounds of the formula (I)

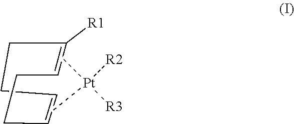

wherein R1 is selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene, and wherein R2 and R3 independently of each other are selected from the group consisting of Cl, I, methyl, phenyl, or phenylacetylene.

While not intending to be bound by any particular theory, it is thought that the asymmetry of the compound of the general formula (I), which is the consequence of the monosubstitution of the 1,5-cycloctadien-ligand, the order of the resulting platinum complex in the liquid phase or the crystal is reduced and the volatility of the precursor is increased, compared with symmetric platinum complexes having an otherwise similar structure (e.g. compounds with disubstituted or unsubstituted 1,5-cycloctadien-ligands). Surprisingly, the thermal stability of the compounds of the present invention is still very good.

In one or more embodiments, if in a compound of formula (I) the substituents R2 and R3 are identical, the compound of formula (I) is available in consistent quality and quantities at low cost, because the synthesis can be conducted in a particularly effective manner.

Thus, in specific embodiments, in the compound according to the invention, the substituents R2 and R3 are identical and each is selected from the group consisting of Cl, I, methyl, phenyl, or phenylacetylene.

In specific embodiments, in the compound according to the invention each of the substituents R2 and R3 comprises a methyl group.

According to one or more embodiments, the compounds of the present invention can be readily evaporated or sublimated at low temperatures, and release the platinum at moderately increased temperature, while at the same time the organic ligands of the organometallic compounds rapidly evaporate.

In specific embodiments, a compound of the present invention is selected from the group consisting of:
dichlorido-η⁴-(1Z,5Z)-1-methylcycloocta-1,5-dien) platinum,
diiodido-η⁴-(1Z,5Z)-1-methylcycloocta-1,5-dien) platinum,
dimethyl-η⁴-((1Z,5Z)-1-methylcycloocta-1,5-dien) platinum,
η⁴-((1Z,5Z)-1-methylcycloocta-1,5-dien)diphenyl platinum,
dichlorido-η⁴-(1Z,5Z)-1-ethylcycloocta-1,5-dien) platinum,
η⁴-((1Z,5Z)-1-ethylcycloocta-1,5-dien)diiodido platinum,
η⁴-((1Z,5Z)-1-ethylcycloocta-1,5-dien)dimethyl platinum,
η⁴-((1Z,5Z)-1-ethylcycloocta-1,5-dien)diphenyl platinum,
dichlorido-η⁴-((1E,5Z)-1-phenylcycloocta-1,5-dien) platinum,
diiodido-η⁴-((1E,5Z)-1-phenylcycloocta-1,5-dien) platinum,
dimethyl-η⁴-((1E,5Z)-1-phenylcycloocta-1,5-dien) platinum,
diphenyl-η⁴-((1E,5Z)-1-phenylcycloocta-1,5-dien) platinum,
dichlorido-η⁴-((1E,5Z)-1-isopropylcycloocta-1,5-dien) platinum,
diiodido-η⁴-((1E,5Z)-1-Isopropylcycloocta-1,5-dien) platinum,
η⁴-((1E,5Z)-1-isopropylcycloocta-1,5-dien)dimethyl platinum,
η⁴-((1Z,5Z)-1-isopropylcycloocta-1,5-dien)diphenyl platinum,
dichlorido-η⁴-((1E,5Z)-1-n-butylcycloocta-1,5-dien) platinum,
diiodido-η⁴-((1E,5Z)-1-n-butylcycloocta-1,5-dien) platinum,
dimethyl-η⁴-((1E,5Z)-1-n-butylcycloocta-1,5-dien) platinum,
diphenyl-η⁴-((1E,5Z)-1-n-butylcycloocta-1,5-dien) platinum,
dichlorido-η⁴-((1E,5Z)-1-iso-butylcycloocta-1,5-dien) platinum,
diiodido-η⁴-((1E,5Z)-1-iso-butylcycloocta-1,5-dien) platinum,
dimethyl-η⁴-((1E,5Z)-1-iso-butylcycloocta-1,5-dien) platinum,
diphenyl-η⁴-((1E,5Z)-1-iso-butylcycloocta-1,5-dien) platinum,
dichlorido-η⁴-((1E,5Z)-1-n-hexylcycloocta-1,5-diene) platinum,
diiodido-η⁴-((1E,5Z)-1-n-hexylcycloocta-1,5-diene) platinum, and
η⁴-((1E,5Z)-1-n-hexylcycloocta-1,5-diene)dimethylplatinum
   preferably preferred selected from the group consisting of
dimethyl-η⁴-((1E,5Z)-1-n-butylcycloocta-1,5-dien) platinum,
dimethyl-η⁴-((1E,5Z)-1-iso-butylcycloocta-1,5-dien) platinum,
η⁴-((1E,5Z)-1-n-hexylcycloocta-1,5-diene)dimethylplatinum, and
dimethyl-η⁴-((1Z,5Z)-1-ethylcycloocta-1,5-dien)-platinum.

Embodiments of another aspect of the invention relate to a method for producing multi-layered dots on a substrate. In one or more embodiments, the method comprises the following steps:
preparing or providing a substrate having one or more dots on its surface, the dots consisting of an innermost layer of a first metal and, optionally, one or more further layers of metal,
contacting a precursor with said substrate having one or more dots, under conditions in which the precursor decomposes into a second metal which is deposited on said layer of said first metal, wherein the second metal is different from the first metal.

In one or more embodiments, the first metal acts to decrease the tendency of the second metal to form larger dots. The tendency of the second metal to form larger dots than the first metal can be determined as described above.

In one or more embodiments, the second metal has a higher catalytic activity than the first metal, for the catalytic application the product will be used for. If this is not clearly defined, in other embodiments, the second metal has a higher catalytic activity than the first metal, for the oxidation of CO to CO₂ in an automotive off-gas test reaction.

The activity of the first and the second metal can be determined in a comparative test as described above.

In one or more embodiments, the first metal and/or the second metal is selected from the group consisting of platinum, palladium, rhodium, iridium, gold, silver, nickel, cobalt, and zinc.

In one or more embodiments, the first metal is selected from the group consisting of platinum, palladium, rhodium, iridium, gold, and silver.

In one or more embodiments, the second metal is selected from the list consisting of gold, silver, nickel, cobalt, and zinc.

In specific embodiments, the first metal is palladium and/or the second metal is platinum.

In one or more embodiments, the metals as listed above are selected so that the first metal acts to decrease the tendency of the second metal to form larger dots and/or wherein the second metal has a higher catalytic activity than the first metal (as to catalytic activity see above).

In one or more embodiments, the substrate is produced by chemical vapor synthesis, by dispersion of metal oxide particles in the gas or liquid phase, by spraying of a suspension of particles and a solvent and evaporation of the solvent, or by synthesis in a flame or plasma reactor.

In one or more embodiments, the substrate having one or more dots on its surface, is produced by metal organic chemical vapor deposition.

In one or more embodiments, the precursor for the deposition of the second metal is a compound of formula (I) as described above.

A method of the present invention is closely related to the product of the present invention. Thus, specific embodiments of the product of the invention as discussed above correspond to specific embodiments of the method of the present invention. In one or more embodiments, the products of the method of the present invention can be used as catalysts.

Thus, in one or more embodiments of the method of the present invention, the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO.

In one or more embodiments of the method of the present invention, the substrate is constituted by an amount of particles having an average Feret diameter in the range of from 12 to 300 nm, specifically in the range of from 25 to 200 nm, more specifically in the range of from 40 to 100 nm

In one or more embodiments of the method of the present invention, the substrate comprises an amount of particles selected from the group consisting of cylindrical, discoidal, tabular, ellipsoidal, equant, irregular, and spherical particles. In specific embodiments, the substrate comprises an amount of spherical particles.

According to one or more embodiments, contacting the compound of formula (I) of the pre sent invention with a substrate or with dots on this substrate is performed during a metal organic chemical vapor deposition process so that the compound of formula (I) decomposes into platinum which is deposited on the dots on the substrate forming multi-layered dots.

In one or more embodiments of the method of the present invention, at least some of the multi-layered dots deposited on the substrate have a mean Feret diameter below 10 nm, specifically in the range of from 0.2 to 8 nm, more specifically in the range of from 0.5 to 4 nm.

In one or more embodiments of the method of the present invention, at least 90% of the multi-layered dots deposited on the substrate have a mean Feret diameter in the range of from 70% to 130%, specifically 80% to 120%, more specifically 90% to 110%, of the average Feret diameter of the multi-layered dots.

In one or more embodiments, the method is at least partly or completely performed under a pressure in the range of from 1 mbar to 2000 mbar, specifically in the range of from 500 mbar to 1500 mbar, more specifically in the range of from 900 mbar to 1200 mbar.

In a specific embodiment, the method of the present invention comprises the steps of:
preparing or providing a substrate having one or more dots on its surface, the dots consisting of an innermost layer of a palladium and, optionally, one or more further layers of metal,
contacting a compound of the formula (I) as described above with said substrate having one or more dots, under conditions in which the compound of the formula (I) decomposes into platinum which is deposited on said layer of said palladium,

wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO,

wherein the substrate consists of an amount of spherical particles,

wherein at least some of the multi-layered dots deposited on the substrate have a mean Feret diameter below 10 nm, specifically in the range of from 0.2 to 8 nm, more specifically in the range of from 0.5 to 4 nm, and

wherein the method is at least partly or completely performed under a pressure in the range of from 900 mbar to 1200 mbar.

In a very specific embodiment, the method according to the present invention comprises the steps of:
preparing or providing a substrate having one or more dots on its surface, the dots consisting of an innermost layer of a palladium and, optionally, one or more further layers of metal,
contacting a compound of the formula (I) as described above with said substrate having one or more dots, under conditions in which the compound of the formula (I) decomposes into platinum which is deposited on said layer of said palladium,

wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO,

wherein the substrate is constituted by an amount of spherical particles having an average Feret diameter in the range of from 40 to 100 nm.

wherein at least some of the multi-layered dots deposited on the substrate have a mean Feret diameter below 10 nm, specifically in the range of from 0.5 to 4 nm, and

wherein the method is at least partly or completely performed under a pressure in the range of from 900 mbar to 1200 mbar.

In other specific embodiments, the method according to the present invention comprises the steps of:
preparing or providing a substrate having one or more dots on its surface, the dots consisting of an innermost layer of a first metal and, optionally, one or more further layers of metal,
contacting a precursor with said substrate having one or more dots, under conditions in which the precursor decomposes into a second metal which is deposited on said layer of said first metal, wherein the second metal is different from the first metal,

wherein the first metal acts to decrease the tendency of the second metal to form larger dots,

wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO, and

wherein at least some of the multi-layered dots deposited on the substrate have a mean Feret diameter below 10 nm, specifically in the range of from 0.2 to 8 nm, more specifically in the range of from 0.5 to 4 nm.

In still further specific embodiments, the method according to the present invention comprises the steps of:
preparing or providing a substrate having one or more dots on its surface, the dots consisting of an innermost layer of a first metal and, optionally, one or more further layers of metal,
contacting a precursor with said substrate having one or more dots, under conditions in which the precursor decomposes into a second metal which is deposited on said layer of said first metal, wherein the second metal is different from the first metal,

wherein the first metal acts to decrease the tendency of the second metal to form larger dots,

wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO, and

wherein the substrate is constituted by an amount of particles having an average Feret diameter in the range of from 40 to 300 nm.

wherein at least some of the multi-layered dots deposited on the substrate have a mean Feret diameter below 10 nm, specifically in the range of from 0.2 to 8 nm, more specifically in the range of from 0.5 to 4 nm.

In another specific embodiment, the method according to the present invention comprises the steps of:
preparing or providing a substrate having one or more dots on its surface, the dots consisting of an innermost layer of a first metal and, optionally, one or more further layers of metal,
contacting a precursor with said substrate having one or more dots, under conditions in which the precursor decomposes into a second metal which is deposited on said layer of said first metal, wherein the second metal is different from the first metal,

wherein the second metal has a higher catalytic activity than the first metal, for the oxidation of CO to CO₂ in an automotive off-gas test reaction,

wherein the substrate consists of or comprises (a) one or more oxides selected from the group consisting of SiO₂, MgO, Al₂O₃, TiO₂, ZrO₂, Y₂O₃, Cr₂O₃, La₂O₃, Fe₂O₃, ZnO, SnO, and carbon and/or (b) one or more mixed oxides of two, three or more oxides selected from the group consisting of SiO₂, MgO, Al₂O₃, TiO₂, ZrO₂, Y₂O₃, Cr₂O₃, La₂O₃, Fe₂O₃, ZnO, and SnO, and

wherein the substrate is constituted by an amount of particles having an average Feret diameter in the range of from 40 to 300 nm.

wherein at least some of the multi-layered dots deposited on the substrate have a mean Feret diameter below 10 nm, specifically in the range of from 0.2 to 8 nm, more specifically in the range of from 0.5 to 4 nm.

Embodiments of an additional aspect of the invention relate to the use of a product of the present invention as a catalyst (heterogeneous catalyst or photocatalyst), as part of an optical sensor, or as part of a gas sensor.

Embodiments of a further aspect of the invention relate to a catalyst system, specifically a catalyst system in a catalytic converter or for asymmetric hydrogenation, comprising or consisting of a product according to the invention.

As used herein, a catalyst system is considered to be a functional unit consisting of or comprising the catalyst. For example, the supporting material or the casing of the catalyst in a catalytic converter are considered to be a part of a catalyst system.

Embodiments of a further aspect of the present invention relate to the use of a product according to the invention as a catalyst, specifically in a catalytic converter or for the asymmetric hydrogenation.

In one or more embodiments, the use of a product according to the invention is as a catalyst in a high temperature process, specifically in a process proceeding at a temperature of more than 300° C., more specifically in a process proceeding at a temperature of more than 500° C.

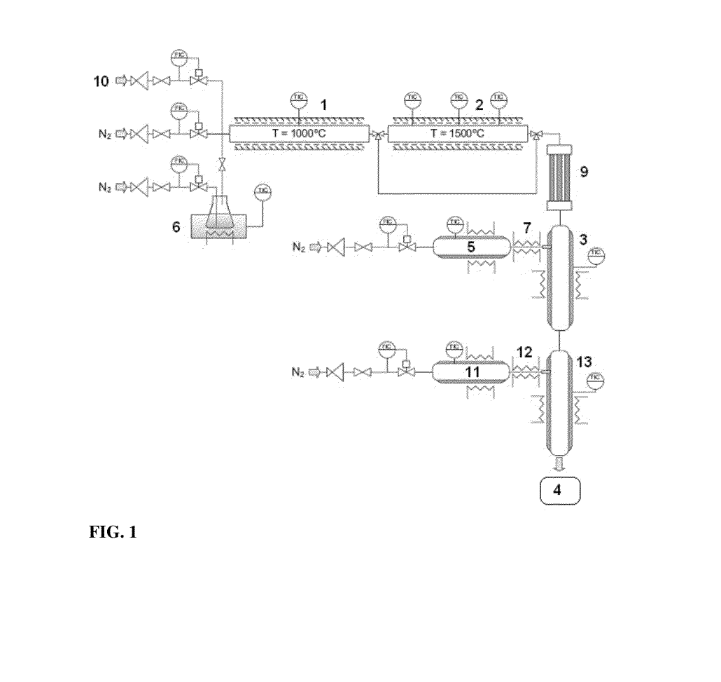

FIG. 1 is a schematic drawing of an assembly for the continuous generation of particles having multi-layered dots on their surface in the aerosol state by a combined CVS/MOCVD/MOCVD process under atmospheric pressure.

As depicted in FIG. 1, according to one or more embodiments, the system consists of a CVS reactor 1) for the production of particles by CVS (chemical vapor synthesis), a sintering furnace 2) for the sintering of the produced particles, and a diffusion dryer 9) in which water can be removed from a particle aerosol produced in the CVS reactor 1) and sintered in the sintering furnace 2).

Referring to FIG. 1, in one or more embodiments, a nitrogen (N₂) stream that is saturated in a bubbling system 6) with a precursor for the CVS, air 10), and additional nitrogen (N₂) can be introduced into the CVS reactor 1), and the synthezised product can be transported into the sintering furnace 2), and subsequently into diffusion dryer 9).

According to one or more embodiments, the assembly, depicted in FIG. 1, further comprises a precursor sublimator for the first precursor 5), a precursor sublimator for the second precursor, a first heated transfer pipe 7), a second heated transfer pipe 12), a coating reactor for the first metal 3), and a coating reactor for the second metal 13).

In one or more embodiments, the metal organic precursor for first MOCVD can be vaporized in the precursor sublimator for the first precursor 5) into a flow of nitrogen (N₂) provided by a nitrogen source. The vaporized first metal organic precursor is subsequently transferred through a heated transfer pipe 7) to the coating reactor for the first metal 3). In the reactor, the particle aerosol that was dried in the diffusion dryer 9) and the vaporized metal organic precursor are mixed, the precursor releases the first metal and the first metal deposition on the substrate (i.e. the particles of the aerosol) takes place. The resulting particles having dots consisting of the first metal on their surface can be transported into the coating reactor for the second metal 13).

In one or more embodiments, the metal organic precursor for second MOCVD can be vaporized in the precursor sublimator for the second precursor 11) into a flow of nitrogen (N₂) provided by a nitrogen source. The vaporized second metal organic precursor is subsequently transferred through a second heated transfer pipe 12) to the coating reactor for the second metal 13). In the reactor the particle aerosol containing particles having dots consisting of the first metal and the vaporized metal organic precursor are mixed, the precursor releases the second metal and the second metal deposition on dots consisting of the first metal takes place. The resulting particles having multi-layered dot(s) consisting of the first metal as the inner layer and of the second metal as an outer layer on their surface 4) can be collected on a membrane, a TEM grid, or can be analyzed via online measuring methods after leaving the coating reactor for the second metal 14).

In one or more embodiments, the temperatures of the CVS reactor 1), sintering furnace 2), diffusion dryer 9), bubbling system 6), precursor sublimate 5) and the precursor sublimate 5) are controlled with Temperature Indicator Controllers (TIC). The flow of the Nitrogen (N₂) and the air 10) is controlled with Flow Indicator Controllers (FIC).

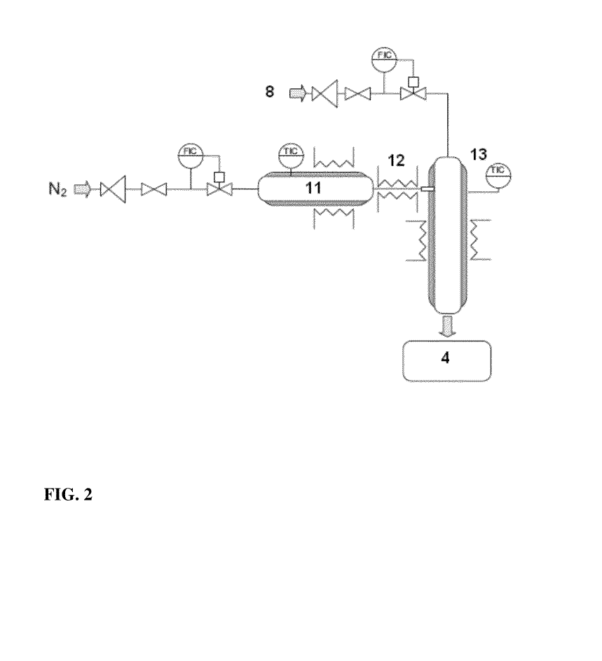

FIG. 2 is as schematic drawing of an assembly for the continuous generation of particles having multi-layered dots on their surface in the aerosol state in a MOCVD process under atmospheric pressure.

According to one or more embodiments, the assembly, as depicted in FIG. 2, comprises a precursor sublimator for the second metal 11), a heated transfer pipe 12), and a coating reactor for the second metal 13).

Referring to FIG. 2, in one or more embodiments, the metal organic precursor for MOCVD can be vaporized in the precursor sublimator for the second metal 11) into a flow of nitrogen (N₂) provided by a nitrogen source. The vaporized metal organic precursor is subsequently transferred through a heated transfer pipe 12) to the coating reactor for the second metal 13). In the reactor, a particle aerosol 8) containing the particles having dots on their surface consisting of the first metal and the precursor vapor are mixed, the precursor releases the second metal and the second metal deposition on dots consisting of the first metal takes place. The resulting particles having multi-layered dot(s) consisting of the first metal as the inner layer and of the second metal as an outer layer on their surface 4) can be collected on a membrane, a TEM grid or can be analyzed via online measuring methods after leaving the coating reactor for the second metall (13).

In one or more embodiments, the temperatures of the precursor sublimator for the first metal (11) and the coating reactor for the second metal (13) are controlled with Temperature Indicator Controllers (TIC). The flow of the Nitrogen (N₂) and the particle aerosol (8) is controlled with Flow Indicator Controllers (FIC).

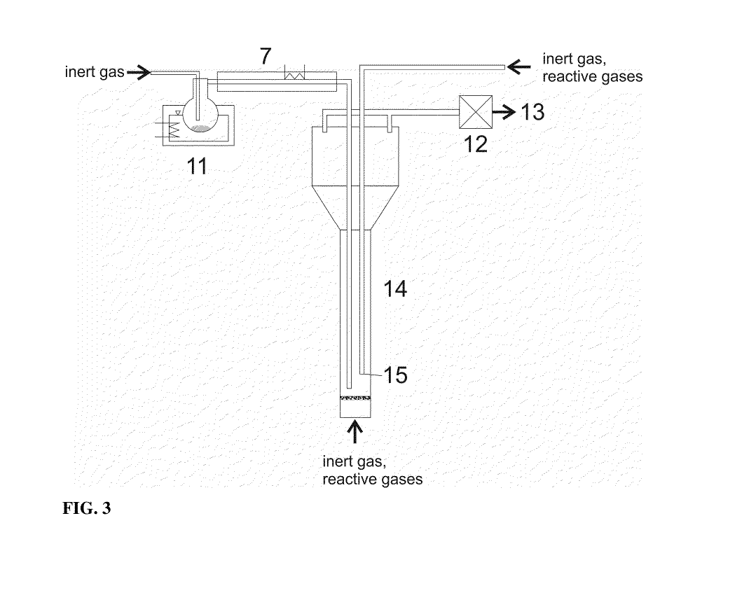

FIG. 3 is a schematic drawing of an assembly for the generation of particles having multi-layered dots on their surface in the aerosol state in a MOCVD process under atmospheric pressure.

According to one or more embodiments, the assembly, as depicted in FIG. 3, comprises a precursor sublimator 14), a fluidized bed reactor 15), a heated transfer pipe 16), and a filter 17).

Referring to FIG. 3, in one or more embodiments, the metal organic precursor for MOCVD can be vaporized in the precursor sublimator 14) into a flow of inert gas (e.g. N₂) provided by an inert gas source. The vaporized metal organic precursor is subsequently transferred through a heated transfer pipe 16) to a fluidized bed reactor 15). The fluidized bed reactor 15) contains substrate particles having dots consisting of the first metal and an inert gas reactive gas mixture (e.g. N₂/O₂) is passed through the particle bed to suspend the particles.

In one or more embodiments, in the fluidized bed reactor 15), the substrate particles having dots consisting of the first metal and the precursor vapor are mixed, the precursor releases the second metal and the second metal dots consisting of the first metal takes place and multi-layered dots are formed. To avoid any loss of particles the exhaust gases 18) pass a filter 17).

The invention is now further described by selected examples and embodiments. These embodiments and examples are intended to represent certain preferred features of the present invention, without limiting the scope of this description or the scope of the claims. It is to be understood that the skilled artisan can devise further working examples and embodiments by his common general knowledge and the instructions and explanations given in this description and the documents incorporated herein by reference.

### EXAMPLES

### Example 1

### General Procedure for the Synthesis of Platinum Complexes of the Type [PtCl₂(1-R-1,5-COD)]

n-Propanol and the monosubstituted 1,5-Cycloocatdiene (6.90 eq.) was added to a solution of K₂PtCl₄ (1.00 eq.) in water. Afterwards SnCl₂ (0.0300 eq.) was added and the mixture was stirred for two to five days at room temperature. The initial dark red to brownish solution became nearly colorless and the formation of a precipitate could be observed. The resulting precipitate was filtered, washed twice with water and once with ethanol or pentane and dried under reduced pressure.

### Example 2

### General Procedure for the Synthesis of Platinum Complexes of the Type [PtI₂(1-R-1,5-COD)]

NaI (2.15 eq.) was added at room temperature to a suspension of PtCl₂(1-R-1,5-COD)] (1.00 eq.; synthesized as described in Example 1) in acetone. The color of the reaction mixture initially turned yellow and the mixture was stirred for three hours. Afterwards the acetone was removed under reduced pressure and the resulting residue was dissolved in a mixture of dichloromethane and water (1:1). The phases were separated, and the organic phase was washed twice with water, dried over sodium sulfate, and filtered. After removal of the solvent under reduced pressure, the desired PtI₂(1-R-1,5-COD) complex could be obtained as a bright yellow to orange solid or wax.

### Example 3

### General Procedure for the Synthesis of Platinum Complexes of the Type [PtMe₂(1-R-1,5-COD]

A solution of MeLi in pentane (1.6 M, 3.00 eq.) was added dropwise at 0° C. to a suspension of [PtI₂(1-R-1,5-COD)] (1.00 eq.; synthesized as described in Example 2) and dry diethyl ether. The color of the reaction mixture turned brown during the reaction. After two hours, an ice-cold ammonium chloride solution was added. The aqueous phase was extracted three times with diethyl ether and the organic phases were collected, dried over sodium sulfate, filtered, and the solvent was removed under reduced pressure. The crude product was slightly yellow and could be purified by column chromatography over silica gel (cyclohexane, 2% triethylamine).

### Example 4

### General Procedure for the Synthesis of Platinum Complexes of the Type [PtPh₂(1-R-1,5-COD)]

PtCl₂(1-R-1,5-COD)] (1.00 eq.; synthesized as described in Example 1) was dissolved in dry diethyl ether. Phenylmagnesium bromide (2 M in tetrahydrofuran, 2.20 eq.) was added dropwise to the mixture. The resulting reaction mixture was stirred for 12 hours at room temperature and treated afterwards with an ammonium chloride solution. The aqueous phase was extracted three times with diethyl ether, the organic phases were collected, dried over sodium sulfate, filtered through Celite and activated carbon, and the solvent was removed under reduced pressure. The resulting colorless solid was recrystallized from dichloromethane and pentane.

### Example 5

### General Procedure for the Synthesis of Platinum Complexes of the Type [PtMe₂(1-R-1,5-COD)]

Pt(acac)₂ (1.00 eq.) and the monosubstituted 1,5-Cycloocatdiene (1.10 eq.) were dissolved in dry toluene. Trimethylaluminium (2.0 M in Toluol, 3.00 eq.) was added dropwise to the solution and the resulting reaction mixture was stirred 24 hours at room temperature. Afterwards the reaction mixture was quenched with an ammonium chloride solution and the organic phase was separated and washed several times with an aqueous 1M hydrochloric acid solution and a sodium chloride solution. The separated organic phase was dried over sodium sulfate, filtered, and the solvent was removed under reduced pressure. The crude product was slightly yellow and could be purified by column chromatography over silica gel (cyclohexane, 2% triethylamine).

### Example 6

### Dichlorido-η⁴-((1Z,5Z)-1-methylcycloocta-1,5-diene)-platinum [PtCl₂(Me-COD)]

The compound was prepared according to the general procedure for the synthesis of platinum complexes of Example 1. 1.01 g (6.90 eq., 8.26 mmol) (1Z,5Z)-1-methylcycloocta-1,5-diene was stirred with 497 mg (1.00 eq., 1.20 mmol) K₂PtCl₄, 5.77 mL n-PrOH, 8.42 mL H₂O and 7.00 mg (0.0300 eq., 36.0 mol) SnCl₂ for two days. 323 mg (0.832 mmol, 70%) of the desired product was obtained as beige solid.

Decomposition temperature: 213° C.

¹H-NMR (400 MHz, CDCl₃): δ (ppm) 1.95 (s d, ²J_{PtH}=17.9 Hz, 3H, CH₃), 2.03-2.09 (m, 1H, CH₂), 2.15-2.50 (m, 4H, CH₂), 2.55-2.68 (m, 1H, CH₂), 2.70-2.90 (m, 2H, CH₂), 5.35-5.55 (dd, ³J_{HH}=6.9 Hz, ⁴J_{HH}=2.8 Hz, 1H, CH), 5.55-5.75 (m, 2H, CH).

¹³C-NMR (100 MHz, CDCl₃): δ (ppm) 29.0 (+, CH₃), 29.4 (−, CH₂), 30.7 (−, CH₂), 31.7 (−, CH₂), 38.0 (−, CH₂), 96.1 (+, CH), 97.7 (+, CH), 99.9 (+, CH), 124.0 (C_{quart}).

¹⁹⁵Pt-NMR (129 MHz, CDCl₃): δ (ppm) −3298 (s).

IR (ATR) [cm⁻¹]: ν⁻¹ 3007 (vw), 2931 (vw), 2879 (vw), 2076 (vw), 1653 (vw), 1511 (vw), 1478 (vw), 1458 (vw), 1430 (w), 1372 (vw), 1348 (vw), 1334 (vw), 1312 (w), 1240 (vw), 1212 (vw), 1172 (vw), 1099 (vw), 1061 (vw), 1039 (vw), 1025 (vw), 1008 (w), 969 (vw), 903 (vw), 874 (vw), 854 (vw), 832 (vw), 798 (w).

UV/Vis (CHCl₃): λₘₐₓ (log ε) 229 (0.71), 250 (0.84), 299 (0.19), 386 (0.07) nm.

MS (70 eV, EI), m/z (%): 390/389/388/387/386 (10/9/17/13/11) [M⁺], 355/354/353/352/351/350 (9/39/36/100/86/74) [M⁺−Cl], 318/317/316/315/314/313/312/311/310/309/308 (13/23/76/84/86/55/60/36/38/28/13) [M⁺]−2×Cl], 286/285/284/283 (14/23/23/13), 273/272/271 (11/12/9), 261/260/259 (10/10/8), 235/234 (9/9), 122 (10) [C₉H₁₄⁺], 107 (13) [C₈H₁₁⁺].

HRMS (PtCl₂C₉H₁₄): calc. 387.0121; found 387.0124.

EA (PtCl₂C₉H₁₄): calc. C 27.85, H 3.64; found C 27.91, H 3.60.

### Example 7

### Diiodido-η⁴-((1Z,5Z)-1-methylcycloocta-1,5-dien)-platinum [PtI₂(Me-COD)]

The compound was prepared according to the general procedure for the synthesis of platinum complexes of Example 2. 50.0 mg (1.00 eq., 0.128 mmol) [PtCl₂(Me-COD)] and 43.2 mg (2.15 eq., 0.258 mmol) NaI in 3 mL acetone were stirred together for three hours. 71.1 mg (0.126 mmol, 97%) of the desired product was obtained as yellow solid.

Decomposition temperature: >170° C.

¹H-NMR (400 MHz, CDCl₃): δ (ppm) 1.70-1.90 (m,1H, CH₂), 1.90-2.20 (m, 3H, CH₂), 2.08 (s d, ²J_{PtH}=20.7 Hz, 3H, CH₃), 2.20-2.40 (m, 2H, CH₂), 2.50-2.61 (m, 1H, CH₂), 2.61-2.80 (m, 1H, CH₂), 5.56-6.02 (m, 3H, CH).

¹³C-NMR (100 MHz, CDCl₃): δ (ppm) 29.8 (−, CH₂), 31.9 (−, CH₂), 32.3 (+, CH₃), 32.5 (−, CH₂), 36.2 (−, CH₂), 99.5 (+, CH), 99.7 (+, CH), 101.1 (+, CH), 128.9 (C_{quart}).

¹⁹⁵Pt-NMR (129 MHz, CDCl₃): δ(ppm) 4240 (s).

IR (ATR) [cm⁻¹]: ν⁻¹ 3000 (vw), 2940 (vw), 2874 (vw), 2825 (vw), 2108 (vw), 1718 (vw), 1511 (vw), 1492 (vw), 1477 (vw), 1423 (w), 1368 (vw), 1347 (vw), 1335 (vw), 1312 (w), 1237 (vw), 1210 (vw), 1191 (vw), 1169 (vw), 1142 (vw), 1095 (w), 1061 (vw), 1036 (vw), 1022 (vw), 1006 (w), 967 (vw), 939 (vw), 895 (vw), 874 (w), 853 (vw).

MS (70 eV, EI), m/z (%): 574/572/571/570 (10/45/60/50) [M⁺], 445/444/443/442/441 (25/30/36/11/15) [M⁺−I], 316/315/314/313/312/311/310 (11/18/12/18/12/17/12) (13/23/76/84/86/55/60/36/38/28/13) [M⁺−2×I], 122 (52) [C₉H₁₄⁺], 107 (39) [C₈H₁₁⁺], 94 (41), 68 (100).

HRMS (PtI₂C₉H₁₄): calc. 570.8833; found 570.8831.

EA (PtI₂C₉H₁₄): calc. C 18.93, H 2.47; found C 19.70, H 2.58.

### Example 8

### Dimethyl-η⁴-((1Z,5Z)-1-methylcycloocta-1,5-dien)platinum [PtMe₂(Me-COD)]

The compound was prepared according to the general procedure for the synthesis of platinum complexes of Example 5. 100 mg (1.00 eq., 0.254 mmol) Pt(acac)₂ and 34.2 mg (1.10 eq., 0.254 mmol) (1Z,5Z)-1-methylcycloocta-1,5-diene were dissolved in 10 mL toluene and 0.381 mL (2.0 M in toluene, 3.00 eq., 0.762 mmol). AlMe₃ was added dropwise. The crude product was purified by column chromatography over silica gel (cyclohexane, 2% triethylamine). 60.0 mg (0.172 mmol, 68%) of the desired product was obtained as slightly yellow solid.

Melting point: 58° C.

¹H-NMR (400 MHz, CDCl₃): δ (ppm) 0.71 (s d, ²J_{PtH}=81.4 Hz, 6H, CH₃), 1.79 (s d,

²J_{PtH}=21.2 Hz, 3H, CH₃), 2.10-2.50 (m, 8H, CH₂), 4.56-4.88 (m, 3H, CH).

¹³C-NMR (100 MHz, CDCl₃): δ (ppm) 2.9 (+, s d, ¹J_{PtC}=762 Hz, PtCH₃), 9.9 (+, s d, ¹J_{PtC}=796 Hz, PtCH₃), 26.7 (−, CH₂), 26.9 (−, CH₂), 29.2 (−, CH₂), 30.2 (−, CH₂), 37.0 (+, CH₃), 97.7 (+, s d, ¹J_{PtC}=54.0 Hz,CH), 98.4 (+, s d, ¹J_{PtC}=60.0 Hz, CH), 98.9 (+, s d, ¹J_{PtC}=44.6 Hz,CH), 115.4 (C_{quart}).

¹⁹⁵Pt-NMR (129 MHz, CDCl₃): δ (ppm) −3521 (s).

IR (ATR) [cm⁻¹]: ν⁻¹ 2992 (vw), 2917 (w), 2864 (m), 2793 (vw), 1524 (vw), 1478 (w), 1425 (w), 1371 (vw), 1345 (vw), 1314 (w), 1260 (vw), 1239 (vw), 1213 (vw), 1193 (w), 1170 (vw), 1144 (vw), 1098 (vw), 1025 (m), 989 (w), 961 (w), 899 (vw), 855 (w), 806 (vw), 786 (m), 734 (vw), 601 (vw), 555 (vw), 540 (m), 459 (w).

MS (70 eV, EI), m/z (%): 350/349/348/347/346 (4/1/16/20/18) [M⁺1], 335/334/333/332/331 (1/1/6/8/7) [M⁺−CH₃], 320/319/318/317/316/315/314/313/312/311 (5/17/23/83/100/82/20/23/13/13) [M⁺−2×CH₃]. HRMS: (PtC₁₁H₂₀): calc. 347.1213; found. 347.1215.

### Example 9

### η⁴-((1Z,5Z)-1-Methylcycloocta-1,5-diene)diphenyl platinum [PtPh₂(Me-COD)]

The compound was prepared according to the general procedure for the synthesis of platinum complexes of Example 4. 50.0 mg (1.00 eq., 0.128 mmol) [PtCl₂(Me-COD)] were reacted with 150 μL (2 M in tetrahydrofuran, 2.20 eq., 0.281 mmol) PhMgCl. The resulting crude o product was recrystallized from dichloromethane and pentane. 55.1 mg (0.115 mmol, 90%) of the desired product was obtained as colorless solid.

Decomposition temperature: >110° C.

¹H-NMR (400 MHz, CDCl₃): δ 1.45 (s d, ²J_{PtC}=23.6 Hz, 3H, CH₃), 2.22-2.69 (m, 8H, CH₂), 4.72-5.18 (m, 3H, CH), 6.77 (t, ³J=7.3 Hz, 2H, C_{Ar}H), 6.96 (t, ³J=7.3 Hz, 4H, C_{Ar}H), 7.00-7.20 (m, 1H, C_{Ar}H), 7.22 (t, ³J=7.3 Hz, 2H, C_{Ar}H).

¹³C-NMR (100 MHz, CDCl₃): δ 28.1 (+, CH₃), 29.3 (−, CH₂), 29.5 (−, CH₂), 29.9 (−, CH₂), 36.7 (−, CH₂), 103.7 (+, CH), 103.9 (+, CH), 104.6 (+, CH), 115.2 (C_{quart}), 121.3 (C_{quart}), 127.2 (+, 2×C_{Ar}), 127.5 (+, 2×C_{Ar}), 128.7 (+, 2×C_{Ar}), 134.5 (+, 2×C_{Ar}), 134.8 (+, 2×C_{Ar}).

¹⁹⁵Pt-NMR (129 MHz, CDCl₃): δ−3564 (s).

IR (ATR) [cm⁻¹]: ν⁻¹ 3335 (vw), 3049 (vw), 2988 (vw), 2937 (w), 1799 (vw), 1568 (m), 1465 (w), 1420 (m), 1371 (vw), 1338 (vw), 1315 (vw), 1258 (w), 1206 (vw), 1171 (vw), 1098 (vw), 1077 (vw), 1059 (w), 1020 (m), 894 (vw), 863 (vw), 844 (vw), 790 (m), 728 (m), 693 (m), 655 (vw), 609 (vw), 551 (vw), 496 (vw), 474 (w).

MS (70 eV, EI), m/z (%): 472/471/470 (8/8/6) [M⁺1], 318/317/316&315/314 (25/30/36/11/15)

[M⁺−2×C₆H₅], 107 (65) [C₈H₁₁⁺].

HRMS (PtC₂₁H₂₄): calc. 471.1525; found 471.1526.

EA (PtC₂₁H₂₄): calc. C 53.49, H 5.13; found C 53.61, H 5.17.

### Example 10

### Dichlorido-η⁴-((1Z,5Z)-1-ethylcycloocta-1,5-dien)platin [PtCl₂(Et-COD)]

The compound was prepared according to the general procedure for the synthesis of platinum complexes of Example 1. 453 mg (6.90 eq., 3.32 mmol) (1Z,5Z)-1-ethylcycloocta-1,5-diene was stirred with 200 mg (1.00 eq., 0.482 mmol) K₂PtCl₄, 2.15 mL nPrOH, 3.12 mL H₂O and 4.00 mg (0.0300 eq., 0.0210 mmol) SnCl₂ for two days. 172 mg (0.424 mmol, 88%) of the desired product was obtained as beige solid.

Decomposition temperature: >144° C.

¹H NMR (400 MHz, CDCl₃): δ (ppm) 1.30 (t, ³J =7.3 Hz, 3H, CH₃), 1.82-2.12 (m, 3H, CH₂), 2.30-2.64 (m, 5H, CH₂), 2.76-2.90 (m, 2H, CH₂CH₃), 5.37-5.73 (m, 3H, CH).

¹³C-NMR (100 MHz, CDCl₃): 12.4 (+, CH₃), 28.3 (−, CH₂), 32.7 (−, CH₂), 33.1 (−, CH₂), 33.9 (−, CH₂), 34.7 (−, CH₂), 96.7 (+, CH), 98.5 (+, CH), 99.2 (+, CH), 128.4 (C_{quart}).

¹⁹⁵Pt-NMR (129 MHz, CDCl₃): δ (ppm) −3315 (s).

IR (ATR) [cm⁻¹]: ν⁻¹ 3409 (vw), 3009 (vw), 2962 (vw), 2930 (vw), 2877 (w), 2834 (vw), 1655 (vw), 1506 (vw), 1491 (vw), 1461 (vw), 1430 (m), 1371 (vw), 1344 (vw), 1316 (w), 1250 (w), 1235 (vw), 1212 (vw), 1187 (vw), 1172 (vw), 1146 (vw), 1105 (vw), 1080 (vw), 1052 (w), 1032 (vw), 1011 (m), 963 (w), 927 (vw), 901 (vw), 878 (w), 857 (vw), 836 (m), 804 (w), 742 (vw), 696 (w), 670 (vw), 620 (w), 528 (vw), 468 (w), 424 (vw).

MS (70 eV, EI), m/z (%): 404/402/401/400 (1/1/1/1) [M⁺1], 367/366/365/364/363 (21/19/52/48/42) [M⁺Cl], 332/331/329/328/327/326/325 (17/12/74/100/97/26/26) [M⁺−2×Cl], 107 (4) [C₈H₁₁⁺].

HRMS (PtCl₂C₁₀H₁₆): calc. 401.0277; found. 401.0275.

EA (PtCl₂C₁₀H₁₆): calc. C 29.86, H 4.01; found C 31.14, H 4.07.

### Example 11

### η⁴-((1Z,5Z)-1-Ethylcycloocta-1,5-diene)diiodido platinum [PtI₂(Et-COD)]

The compound was prepared according to the general procedure for the synthesis of platinum complexes of Example 2. 142 mg (1.00 eq., 0.353 mmol) [PtCl₂(Et-COD)] and 114 mg (2.15 eq., 0.760 mmol) NaI in 8.5 mL acetone were stirred together for three hours. 206 mg (0.351 mmol, 99%) of the desired product was obtained as yellow solid.

Decomposition temperature: >104° C.

¹H-NMR (400 MHz, CDCl₃): δ (ppm) 1.24 (t, ³J_{HH}=7.3 Hz, 3H, CH₃), 1.70-2.58 (m, 8H, CH₂), 2.62-2.82 (m, 2H, CH₂CH₃), 5.52-5.82 (m, 2H, CH), 5.92 (d d, ³J_{HH}=6.3 Hz, ²J_{PtH}=53.0 Hz, 1H, CH).

¹³C-NMR (100 MHz, CDCl₃): δ (ppm) 12.0 (+, CH₃), 28.5 (−, CH₂), 31.9 (−, CH₂), 32.9 (−, CH₂), 35.2(−, CH₂), 37.1 (−, CH₂), 99.3 (+, CH), 99.7 (+, CH), 100.9 (+, CH), 133.7 (C_{quart}).

¹⁹⁵Pt-NMR (129 MHz, CDCl₃): δ (ppm) 4268 (s).

IR (ATR) [cm⁻¹]: ν⁻¹ 2924 (w), 2876 (vw), 2828 (vw), 1655 (vw), 1479 (w), 1448 (w), 1424 (m), 1374 (w), 1353 (vw), 1336 (w), 1304 (w), 1245 (w), 1184 (vw), 1169 (vw), 1143 (vw), 1094 (w), 1067 (w), 1039 (vw), 1002 (w), 977 (vw), 951 (w), 921 (vw), 893 (vw), 876 (w), 851 (vw), 828 (m), 798 (vw), 745 (w), 694 (vw), 554 (vw), 530 (w), 462 (vw), 433 (vw).

UV/Vis (CHCl₃): λₘₐₓ (log ε) 227 (0.57), 229 (0.57), 250 (0.66), 299 (0.15), 382 (0.04) nm.

MS (70 eV, EI), m/z (%): 587/586/585/584/583 (19/7/81/100/91) [M⁺], 461/459/458/457/456/455/453 (8/43/36/72/18/46/11) [M⁺−I], 331/330/329/328/327/326/325 (28/34/53/35/45/22/27) [M⁺−2×I], 136 (18) [C₁₀H₁₆⁺], 121 (8) [C₉H₁₃⁺], 107 (33) [C₈H₁₁⁺],

HRMS (PtI₂C₁₀H₁₆): calc. 584.8989; found 584.8992. EA (PtI₂C₁₀H₁₆): calc. C 20.53, H 2.76; found C 22.10 H 2.84.

### Example 12

### η⁴-((1Z,5Z)-1-Ethylcycloocta-1,5-diene)dimethyl platinum [PtMe₂(Et-COD)]

The compound was prepared according to the general procedure for the synthesis of platinum complexes of Example 3. 125 mg (1.00 eq., 0.214 mmol) [PtI₂(Et-COD)] and 430 μL MeLi (1.6 M in pentane, 3.00 eq., 0.641 mmol) were stirred together for two hours at 0° C. and then worked up. 63.3 mg (0.175 mmol, 82%) of the desired product was obtained as yellow oil.

¹H-NMR (400 MHz, CDCl₃): δ (ppm) 0.69 (s d, ²J_{PtH}=81.4 Hz, 6H, CH₃), 1.06 (t, ³J_{HH}=7.4 Hz, 3H, CH₃), 1.88-2.56 (m, 10H, CH₂), 5.28-5.37 (m, 1H, CH), 5.45-6.64 (m, 2H, CH).

¹³C-NMR (100 MHz, CDCl₃): δ (ppm) 3.7 (+, PtCH₃), 9.3 (+, PtCH₃), 13.8 (+, CH₃), 27.3 (−, CH₂), 28.1 (−, CH₂), 31.3 (−, CH₂), 32.6 (−, CH₂), 33.2 (−, CH₂), 97.7 (+, s d, ¹J_{PtC}=61.2 Hz, CH), 97.7 (+, s d, ¹J_{PtC}=55.2 Hz, CH), 98.9 (+, s d, ¹J_{PtC}=46.0 Hz, CH), 141.3 (C_{quart}).

¹⁹⁵Pt-NMR (129 MHz, CDCl₃): δ (ppm) −3534 (s).

IR (KBr) [cm⁻¹]: ν⁻¹ 3442 (vw), 2927 (m), 2877 (vw), 1736 (vw), 1482 (vw), 1429 (w), 1374 (vw), 1339 (vw), 1315 (vw), 1216 (vw), 1099 (vw), 1056 (vw), 1001 (vw), 935 (vw), 870 (vw), 787 (vw), 540 (vw).

MS (70 eV, EI), m/z (%): 364/362/361/360 (4/18/22/19) [M⁺], 347/346/345 (7/8/7) [M⁺−CH₃], 333/332/331/330/329/328/327/326 (14/13/75/69/100/67/77/21) [M⁺−2×CH₃], 107 (5) [C₈H₁₁⁺].

HRMS (PtC₁₂H₂₂): calc. 361.1370; found 361.1371.

### Example 13

### η⁴-((1Z,5Z)-1-ethylcycloocta-1,5-dien)diphenyl platinum [PtPh₂(Et-COD)]

The compound was prepared according to the general procedure for the synthesis of platinum complexes of Example 4.

20.0 mg (1.00 eq., 49.7 μmol) [PtCl₂(Et-COD)] was reacted with 50.0 μL (2 M in THF, 2.20 eq., 0.110 mmol) PhMgCl. 18.2 mg (37.3 μmol, 75%) of the desired product was obtained as colorless solid.

¹H-NMR (400 MHz, CDCl₃): δ 0.94 (t, ³J=7.0 Hz, 3H, CH₃), 1.88 (q, ³J=7.0 Hz, 2H, CH₂), 2.15-2.80 (m, 8H, CH₂), 4.85-5.10 (m, 3H, CH), 6.80-6.88 (m, 3H, C_{Ar}H), 6.88-7.00 (m, 3H, C_{Ar}H), 7.00-7.20 (m, 1H, C_{Ar}H), 7.20-7.30 (m, 4H, C_{Ar}H).

¹⁹⁵Pt-NMR (129 MHz, CDCl₃): δ−3557 (s).

IR (KBr) [cm⁻¹]: ν⁻¹ 3345 (br), 3057 (w), 2927 (m), 1944 (w), 1876 (w), 1711 (vw), 1595 (m), 1569 (m), 1500 (w), 1480 (m), 1429 (m), 1375 (w), 1344 (w), 1263 (w), 1170 (w), 1073 (m), 1023 (w), 903 (m), 812 (w), 730 (m), 697 (m), 610 (w), 509 (vw), 461 (w).

MS (70 eV, EI), m/z (%): 486/485/484 (13/16/12) [M⁺], 332/330/329/328/326 (9/35/42/41/8) [M⁺−2×Ph], 136 (12) [C₁₀H₁₆⁺], 121 (12) [C₉H₁₃⁺], 107 (100) [C₈H₁₁⁺], 91 (49) [C₇H₇⁺], 67 (35) [C₅H₇⁺].

HRMS (PtC₂₂H₂₆): calc. 485.1682 found 485.1685.

### Example 14

### Dichlorido-η⁴-((1E,5Z)-1-phenylcycloocta-1,5-diene)platinum [PtCl₂(Ph-COD)]

The compound was prepared according to the general procedure for the synthesis of platinum complexes of Example 1. 305 mg (6.90 eq., 1.66 mmol) (1E,5Z)-1-phenylcycloocta-1,5-diene was reacted with 100 mg (1.00 eq., 0.241 mmol) K₂PtCl₄, 1.08 mL nPrOH, 1.56 mL H₂O and 2.00 mg (0.0300 eq., 1.00 μmol) SnCl₂ for two days. 63.1 mg (1.26 mmol, 76%) of the desired product was obtained as yellow solid.

Decomposition temperature: >200° C.

¹H-NMR (400 MHz, CDCl₃): δ 2.00-2.15 (m, 1H, CH₂), 2.35-2.52 (m, 2H, CH₂), 2.53-2.73 (m, 2H, CH₂), 2.78-2.93 (m, 1H, CH₂), 2.96-3.09 (m, 1H, CH₂), 3.11-3.24 (m, 1H, CH₂), 5.59-5.89 (m, 2H, CH), 6.04-6.28 (m, 1H, CH), 7.32-7.36 (m, 2H, C_{Ar}H), 7.37-7.43 (m, 1H, C_{Ar}H), 7.51-7.56 (d, ³J=7.3 Hz, 2H, C_{Ar}H).

¹³C-NMR (100 MHz, CDCl₃): δ 29.3 (−, CH₂), 32.7 (−, CH₂), 33.4 (−, CH₂), 38.1(−, CH₂), 91.8 (+, CH), 98.3 (+, CH), 100.4 (+, CH), 120 (C_{quart}), 127.7 (+, C_{Ar}H), 128.4 (+, C_{Ar}H), 130.1 (+, C_{Ar}H).

¹⁹⁵Pt-NMR (129 MHz, CDCl₃): δ−3191 (s).

IR (ATR) [cm⁻¹]: ν⁻¹ 3015 (w), 2882 (w), 2829 (vw), 1595 (w), 1571 (vw), 1523 (w), 1483 (m), 1449 (w), 1420 (w), 1339 (w), 1302 (vw), 1273 (vw), 1191 (w), 1095 (vw), 1074 (w), 1024 (w), 989 (w), 978 (vw), 921 (w), 874 (vw), 849 (w), 807 (w), 756 (m), 737 (w), 696 (m), 635 (vw), 598 (w), 529 (w), 499 (m).

MS (70 eV, EI), m/z (%): 451/450/449/448/447 (8/8/15/11/9) [M⁺], 416/414/413/412 (6/16/16/13) [M⁺−Cl], 379/378/377 (6/7/12) [M⁺−2×Cl], 184 (98) [C₁₄H₁₆⁺], 129 (100) [C₁₀H₉⁺], 1, 107 (13) [C₈H₁₁⁺]. HRMS (C₁₆H₂₂Cl₂Pt): calc. 449.0277; found 449.0275.

### Example 15

### Diiodido-η⁴-((1E,5Z)-1-phenylcycloocta-1,5-dien)platinum [PtI₂(Ph-COD)]

The compound was prepared according to the general procedure for the synthesis of platinum complexes of Example 2. 50.0 mg (1.00 eq., 0.111 mmol) [PtCl₂(Ph-COD)] and 35.8 mg (2.15 eq., 0.238 mmol) NaI in 3 mL acetone were stirred together for three hours. 73.9 mg (0.110 mmol, 99%) of the desired product was obtained as orange solid.

Decomposition temperature: >151° C.

¹H-NMR (400 MHz, CDCl₃): δ 1.78-1.98 (m, 1H, CH₂), 2.00-2.55 (m, 4H, CH₂), 2.55-2.73 (m, 1H, CH₂), 2.78-2.93 (m, 1H, CH₂), 3.04-3.18 (m, 1H, CH₂), 5.75-6.05 (m, 2H, CH), 6.39 (td, ³J=7.0 Hz, ²J_{PtC}=34.4 Hz, 1H, CH), 7.31-7.40 (m, 3H, C_{Ar}H), 7.48-7.55 (m, 2H, C_{Ar}H).

¹³C-NMR (100 MHz, CDCl₃): δ 29.7 (−, CH₂), 33.1 (−, CH₂), 35.2 (−, CH₂), 36.5(−, CH₂), 94.8 (+, CH), 100.5 (+, CH), 102.0 (+, CH), 125.5 (C_{quart}), 126.2 (+, C_{Ar}H), 127.5 (+, C_{Ar}H), 128.1 (+, C_{Ar}H), 129.8 (+, C_{Ar}H), 142.3 (+, C_{Ar}H).

¹⁹⁵Pt-NMR (129 MHz, CDCl₃): δ−4150 (s).

IR (ATR) [cm⁻¹]: ν⁻¹ 3052 (vw), 3013 (vw), 2915 (vw), 2873 (w), 1653 (vw), 1595 (w), 1473 (w), 1439 (w), 1426 (vw), 1410 (vw), 1339 (w), 1305 (w), 1253 (vw), 1208 (vw), 1180 (vw), 1166 (vw), 1099 (vw), 1073 (vw), 1026 (vw), 1008 (vw), 987 (vw), 950 (w), 906 (vw), 881 (w), 856 (w), 832 (vw), 798 (w), 758 (w), 741 (m), 693 (m), 647 (vw), 586 (w), 551 (w), 514 (vw), 486 (vw), 454 (w).

UV/Vis (CHCl₃): λₘₐₓ (log ε) 231 (0.78), 296 (0.37), 382 (0.07), 394 (0.07) nm.

MS (70 eV, EI), m/z (%): 635/633/632/631 (5/26/33/26) [M⁺], 508/506/505/504 (8/33/39/36) [M⁺−I], 379/378/377/375 (6/11/17/11) [M⁺−2×I], 185/184 (18/100) [C₁₆H₁₆⁺], 129 (87) [C₁₀₉⁺], 115 (65) [C₉H₇⁺].

HRMS (C₁₆H₂₂I₂Pt): calc. 632.8989; found 632.8992.

EA (C₁₆H₂₂I₂Pt): calc. C 26.56, H 2.55; found C 27.67, H 2.66.

### Example 16

### Dimethyl-η⁴-((1E,5Z)-1-phenylcycloocta-1,5-diene)platinum [PtMe₂(Ph-COD)]

The compound was prepared according to the general procedure for the synthesis of platinum complexes of Example 3. 30.0 mg (1.00 eq., 47.3 μmol) [PtMe₂(Ph-COD)] and 95.0 μL (1.6 M in pentane, 3.00 eq., 0.142 mmol) MeLi were stirred together for two hours at 0° C. and then worked up. 15.5 mg (37.4 μmol, 79%) of the desired product was obtained as a slightly yellow solid.

Decomposition temperature: >100° C.

¹⁹⁵Pt-NMR (129 MHz, CDCl₃): δ−3401 (s).

IR (ATR) [cm⁻¹]: ν⁻¹ 2917 (vw), 2871 (w), 1595 (w), 1475 (w), 1439 (w), 1340 (w), 1307 (w), 1257 (w), 1179 (vw), 1095 (vw), 1075 (w), 1001 (m), 947 (w), 881 (w), 856 (w), 832 (vw), 798 (m), 756 (m), 742 (w), 691 (m), 648 (vw), 621 (w), 606 (w), 588 (w), 553 (m), 514 (w), 485 (w), 457 (w), 406 (w). MS (70 eV, EI), m/z (%): 412/411/410/409/408 (1/1/1/1/1) [M⁺], 397/395/394/393 (1/1/1/1) [M⁺−CH₃], 379/378/377 (1/1/1) [M⁺−2×CH₃], 184 (100) [C₁₆H₁₆⁺], 143 (92) [C₁₁H₁₁⁺], 130 (84) [C₁₀H₁₀⁺], 115 (22) [C₉H₇⁺], 107 (1) [C₈H₁₁⁺].

HRMS (C₁₈H₂₈Pt): calc. 409.1369; found 409.1367.

### Example 17

### Diphenyl-η⁴-((1E,5Z)-1-phenylcycloocta-1,5-diene)platinum [PtPh₂(Ph-COD)]

The compound was prepared according to the general procedure for the synthesis of platinum complexes of Example 4. 10.0 mg (1.00 eq., 22.2 μmol) [PtCl₂(Ph-COD)] was reacted with 22.0 μL (2 M in tetrahydrofuran, 2.20 eq., 48.8 μmol) PhMgCl. 6.00 mg (11.1 μmol, 50%) of the desired product was obtained as slightly yellow solid.

¹⁹⁵Pt-NMR (129 MHz, CDCl₃): δ−3548 (s).

IR (KBr) [cm⁻¹]: ν⁻¹ 3355 (br), 3033 (w), 2930 (vw), 1944 (w), 1876 (w), 1748 (vw), 1595 (m), 1569 (w), 1499 (w), 1479 (m), 1453 (vw), 1429 (w), 1374 (vw), 1344 (w), 1235 (m), 1169 (w), 1074 (m), 1024 (vw), 1008 (w), 903 (m), 812 (w), 754 (vw), 737 (m), 697 (m), 610 (w), 544 (vw), 508 (w), 460 (vw).

MS (70 eV, EI), m/z (%): 536/535/534/533/532/530 (1/1/1/1/1/1) [M⁺], 458/457/456 (1/1/1) [M⁺−C₆H₅], 379/378/377 (1/1/1) [M⁺−2×C₆H₅], 184 (6) [C₁₄H₁₆⁺], 166 (24) [C₁₃H₁₀⁺], 107 (100) [C₈H₁₁⁺].

HRMS (C₂₈H₃₂Pt): calc. 533.1683 found 533.1680.

### Example 18

### Dichlorido-η⁴⁻⁽⁽1E,5Z)-1-isopropylcycloocta-1,5-diene)platinum [PtCl₂(iPr-COD)]

The compound was prepared according to the general procedure for the synthesis of platinum complexes of Example 1. 250 mg (6.90 eq., 1.66 mmol) (1E,5Z)-1-isopropylcycloocta-1,5-diene was reacted with 105 mg (1.00 eq., 0.241 mmol) K₂PtCl₄, 1.10 mL n-PrOH, 1.60 mL H₂O and 2.00 mg (0.0300 eq., 10.0 μmol) SnCl₂for two days. 95.5 mg (0.219 mmol, 91%) of the desired product was obtained as a slightly yellow solid.

Decomposition temperature: >150° C.

¹H-NMR (400 MHz, CDCl₃): δ (ppm) 0.95 (d, ³J_{HH}=6.9 Hz, 6H, CH₃), 2.20 (sept, ³J_{HH}=6.9 Hz, 1H, CH(CH₃)₂), 2.25-2.42 (m, 8H, CH₂), 5.46-5.56 (m, 2H, CH), 5.56-5.66 (m, 1H, CH).

¹³C-NMR (100 MHz, CDCl₃): δ (ppm) 21.0 (+, 2×CH₃), 26.3 (−, CH₂), 27.2 (−, CH₂), 27.7 (−, CH₂), 29.9 (−, CH₂), 36.4 (+, CH), 119.5 (+, CH), 127.6 (+, CH), 127.7 (+, CH), 144.2 (C_{quart}).

¹⁹⁵Pt-NMR (129 MHz, CDCl₃): δ (ppm) −3307 (s).

IR (ATR) [cm⁻¹]: ν⁻¹ 3009 (vw), 2963 (w), 2928 (vw), 2885 (vw), 1654 (vw), 1481 (vw), 1459 (vw), 1424 (w), 1381 (vw), 1360 (vw), 1336 (vw), 1308 (w), 1251 (vw), 1194 (vw), 1176 (vw), 1089 (vw), 1062 (w), 1036 (vw), 1025 (vw), 1010 (m), 968 (vw), 887 (vw), 859 (w), 829 (w), 800 (vw), 778 (vw), 734 (vw), 697 (vw), 664 (vw), 612 (w), 580 (vw), 542 (vw), 500 (vw), 468 (w).

MS (70 eV, EI), m/z (%): 419/418/417/416/415/414/412 (1/1/1/1/1/1/1) [M⁺], 382/381/380/379/378 (7/6/16/16/15) [M⁺−Cl], 344/343/342/341/340 (29/36/38/14/14) [M⁺−2×Cl], 300/299/298/297 (13/11/25/12), 150 (24) [C₁₁H₁₈⁺], 135 (25) [C₁₀H₁₅⁺], 107 (77) [C₈H₁₁⁺], 91 (52), 81 (100), 79 (97), 67 (59), 43 (45). HRMS (PtCl₂C₁₁l H₁₈): calc. 415.0434; found 415.0437.

### Example 19

### Diiodido-η⁴-((1E,5Z)-1-isopropylcycloocta-1,5-diene) platinum [PtI₂(iPr-COD)]

The compound was prepared according to the general procedure for the synthesis of platinum complexes of Example 2. 10.0 mg (1.00 eq., 0.0240 mmol) [PCl₂(iPr-COD)] and 7.70 mg (2.15 eq., 51.6 μmol) NaI in 0.50 mL acetone were stirred together for three hours. 14.0 mg (0.0230 mmol, 97%) of the desired product was obtained as yellow solid.

¹H-NMR (300 MHz, CDCl₃): δ (ppm) 0.95 (dd, ²J_{HH}=64.0 Hz, ³J_{HH}=6.7 Hz, 6H, CH₃), 2.32-2.80 (m, 8H, CH₂), 3.38 (sept, ³J=6.7 Hz, 1H, CH(CH₃)₂), 5.52-5.92 (m, 3H, CH).

¹³C-NMR (100 MHz, CDCl₃): δ (ppm) 21.2 (+, 2×CH₃), 26.4 (−, CH₂), 27.9 (−, CH₂), 28.8 (−, CH₂), 30.2 (−, CH₂), 38.3 (+, CH), 121.1 (+, CH), 130.2 (+, CH), 130.6 (+, CH), 148.0 (C_{quart})

¹⁹⁵Pt-NMR (129 MHz, CDCl₃): δ (ppm) −4255 (s).

IR (ATR) [cm⁻¹]: ν⁻¹ 3006 (vw), 2923 (w), 2880 (vw), 1655 (vw), 1499 (vw), 1475 (w), 1424 (w), 1374 (vw), 1337 (w), 1308 (vw), 1222 (vw), 1172 (w), 1086 (w), 1067 (vw), 1036 (vw), 1004 (w), 961 (vw), 907 (vw), 887 (vw), 865 (w), 824 (w), 799 (w), 776 (vw), 732 (w), 694 (w), 608 (w), 569 (vw), 502 (vw), 459 (m).

MS (70 eV, EI), m/z (%): 598/597 (14/13) [M⁺], 557/556/555 (18/16/24), 507/506/505 (24/23/22), 471/470/469 (13/17/13) NIL 380/379 (27/24), 345/344/343/342/341/340 (41/72/100/69/50/25) [M⁺−2×I], 150 (13) [C₁₁H₁₈⁺], 135 (14) [C₁₀H₁₅⁺], 107 (36) [C₈H₁₁⁺], 91 (39), 79 (53), 67 (35), 43 (21).

HRMS (PtI₂C₁₁H₁₈): calc. 598.9146; found 598.9142.

### Example 20

### η⁴-((1E,5Z)-1-Isopropylcycloocta-1,5-dien)dimethylplatin [PtMe₂(iPr-COD)]

The compound was prepared according to the general procedure for the synthesis of platinum complexes of Example 5. 374 mg (1.00 eq., 950 μmol) Pt(acac)₂ and 157 mg (1.10 eq., 1.04 mmol) (1E,5Z)-1-isopropylcycloocta-1,5-diene were dissolved in toluene (37 mL) and 1.43 mL (2.0 m in toluene, 3.00 eq., 2.85 mmol) AlMe₃ was added dropwise. The reaction mixture was worked up after 24 hours. 168 mg (448 μmol, 47%) of the desired product was obtained as a slightly yellow solid.

Melting point: 54° C.

¹H-NMR (400 MHz, CDCl₃): δ (ppm) 0.62 (d d, ²J_{PtH}=81.2 Hz, ³J_{HH}=2.4 Hz, 6H, CH(CH₃)₂), 0.90 (d, ³J_{HH}=6.9 Hz, 3H, CH₃), 1.05 (d, ³J_{HH}=6.9 Hz, 3H, CH₃), 1.80-1.92 (m, 1H, CH(CH₃)₂), 1.94-2.16 (m, 3H, CH₂), 2.20-2.50 (m, 4H, CH₂), 2.54-2.66 (m, 1H, CH₂), 4.42-4.58 (m, 1H, CH), 4.61-4.82 (m, 2H, CH).

¹³C-NMR (100 MHz, CDCl₃): δ (ppm) 3.9 (+, 2×PtCH₃), 9.2 (+, 2×CH(CH₃)₂), 26.5 (−, CH₂), 27.1 (−, CH₂), 32.2 (−, CH₂), 33.3 (−, CH₂), 36.8 (+, CH(CH₃)₂), 97.0 (+, s d, ¹J_{PtC}=62.6 Hz,CH), 97.9 (+, s d, ¹J_{PtC}=57.2 Hz,CH), 99.1 (+, s d, ¹J_{PtC}=47.6 Hz,CH), 124.2 (C_{quart}).

¹⁹⁵Pt-NMR (129 MHz, CDCl₃): δ (ppm) −3526 (s).

IR (ATR) [cm⁻¹]: ν¹ 3442 (vw), 2957 (m),2927 (vw), 2874 (w), 2834 (vw), 2797 (vw), 1524 (vw), 1483 (vw), 1462 (vw), 1431 (w), 1381 (vw), 1358 (vw), 1340 (vw), 1310 (vw), 1284 (vw), 1216 (vw), 1196 (vw), 1165 (vw), 1088 (vw), 1065 (w), 1037 (vw), 999 (vw), 956 (vw), 925 (vw), 875 (vw), 859 (vw), 814 (vw), 783 (vw), 729 (vw), 603 (vw), 557 (vw), 538 (vw), 450 (vw).

MS (70 eV, EI), m/z (%): 376/375/374 (9/11/11) [M⁺], 361/360/359 (9/12/9) [M⁺−CH₃], 345/344/343/342/341/340/339 (55/66/100/75/70/21/22) [M⁺−2×CH₃], 299 (11), 297 (12), 91 (14), 77 (10).

HRMS (PtC₁₃H₂₄): calc. 375.1526; found 375.1524.

### Example 21

### η⁴-((1Z,5Z)-1-isopropylcycloocta-1,5-diene)diphenylplatinum [PtPh₂(iPr-COD)]

The compound was prepared according to the general procedure for the synthesis of platinum complexes of Example 5. 30.0 mg (1.00 eq., 89.0 nmol) [PtCl₂(iPr-COD)] was reacted with 88.0 μL (2 M in tetrahydrofuran, 2.20 eq., 0.196 mmol) PhMgCl. 12.7 mg (29.4 nmol, 35%) of the desired product was obtained as a slightly yellow solid.

IR (KBr) [cm⁻¹]: ν⁻¹ 3233 (br), 3031 (vw), 2925 (w), 1657 (vw), 1593 (w), 1569 (vw), 1535 (vw), 1475 (w), 1429 (vw), 1377 (vw), 1169 (w), 1041 (m), 903 (vw), 754 (vw), 735 (m), 695 (m), 608 (vw), 544 (vw), 510 (w).

MS (70 eV, EI), m/z (%): 500/499/498 (24/28/23) [M⁺], 347/346/345/344/343/342/341 (20/24/22/64/74//77/28) [M⁺2×Ph], 297 (18), 281 (17), 230 (23), 183 (41), 150 (20) [C₁₁H₁₈], 135 (23) [C₁₀H₁₅⁺], 131 (74), 121 (30) [C₉H₁₃⁺], 107 (73) [C₈H₁₁⁺], 95 (35) [C₇H₁₁⁺], 91 (98), 81 (83) [C₆H₉⁺], 79 (100), 67 (53) [C₅H₇⁺], 43 (64) [C₃H₇⁺].

HRMS (C₂₃H₂₈Pt): calc. 499.1839; found 499.1839.

### Example 22

### Dichlorido-η⁴-((1E,5Z)-1-n-butylcycloocta-1,5-diene) platinum [PtCl₂(nBu-COD)]

The compound was prepared according to the general procedure for the synthesis of platinum complexes of Example 1. 503 mg (6.90 eq., 3.06 mmol) (1E,5Z)-1-n-butylcycloocta-1,5-diene was reacted with 184 mg (1.00 eq., 0.444 mmol) K₂PtCl₄, 2.03 mL n-PrOH, 2.95 mL H₂O and 2.50 mg (0.0300 eq., 13.3 nmol) SnCl₂ for five days. 180 mg (0.418 mmol, 94%) of the desired product was obtained as a slightly yellow solid.

Decomposition temperature: >143° C.

¹H-NMR (400 MHz, CDCl₃): δ (ppm) 0.86 (t, ³J=7.2 Hz, 3H, CH₃), 1.19-1.33 (m, 2H, CH₂), 1.40-1.48 (m, 1H, CH₂), 1.74-2.04 (m, 4H, CH₂), 2.16-2.57 (m, 5H, CH₂), 2.70-2.81 (m, 2H, CH₂), 5.42-5.34 (m, 3H, CH).

¹³C-NMR (100 MHz, CDCl₃): δ (ppm) 13.8 (+, CH₃), 22.7 (−, CH₂), 28.4 (−, CH₂), 30.2 (−, CH₂), 32.4 (−, CH₂), 32.8 (−, CH₂), 34.3 (−, CH₂), 41.3 (−, CH₂), 96.7 (+, CH), 98.2 (+,CH), 99.3 (+,CH), 128.1 (C_{quart}).

¹⁹⁵Pt-NMR (129 MHz, CDCl₃): δ (ppm) −3307 (s).

IR (KBr) [cm⁻¹]: ν⁻¹ 2956 (s), 2929 (w), 2867 (s), 1502 (vs), 1484 (m), 1464 (s), 1431 (w), 1412 (s), 1379 (s), 1335 (s), 1317 (m), 1246 (s), 1191 (s), 1171 (vs), 1098 (m), 1083 (s), 1041 (s), 1009 (w), 975 (s), 948 (s) 919 (m), 901 (s), 876 (m), 854 (s), 836 (m), 803 (m), 763 (s), 727 (s), 699 (s), 567 (vw), 549 (vs), 477 (m), 437 (s), 421 (s), 404 (s).

MS (70 eV, EI), m/z (%): 396/395/394/393/392 (14/12/37/37/27) [M⁺−Cl], 358/357/356/355/354 (61/69/100/71/72) [M⁺−2×Cl], 164 (23) [C₁₂H₂₀⁺], 107 [C₈H₁₁⁺], 79 (22), 68 (16), 41 (10).

HRMS (M⁺−Cl, C₁₂H₂₀ClPt): calc. 394.0902; found 394.0901.

### Example 23

### Diiodido-η⁴-((1E,5Z)-1-n-butylcycloocta-1,5-diene) platinum [PtI₂(nBu-COD)]

The compound was prepared according to the general procedure for the synthesis of platinum complexes of Example 2.

140 mg (1.00 eq., 0.325 mmol) [PCl₂(nBu-COD)] and 105 mg (2.15 eq., 0.700 mmol) NaI in 8 mL acetone were stirred together for three hours. 169 mg (0.276 mmol, 85%) of the desired product was obtained as an orange wax.

¹H-NMR (400 MHz, CDCl₃): δ (ppm) 0.85 (t, ³J=7.2 Hz, 3H, CH₃), 1.19-1.31 (m, 2H, CH₂), 1.34-1.43 (m, 1H, CH₂), 1.67-2.07 (m, 6H, CH₂), 2.10-2.20 (m, 1H, CH₂), 2.34-2.40 (m, 1H, CH₂), 2.47-2.76 (m, 3H, CH₂), 5.45-5.94 (m, 3H, CH).

¹³C-NMR (100 MHz, CDCl₃): δ (ppm) 13.8 (+, CH₃), 22.4 (−, CH₂), 28.6 (−, CH₂), 29.8 (−, CH₂), 32.4 (−, CH₂), 32.8 (−, CH₂), 35.0 (−, CH₂), 43.8 (−, CH₂), 99.3 (+, CH), 99.4 (+,CH), 100.7 (+,CH), 133.4 (C_{quart}).

¹⁹⁵Pt-NMR (129 MHz, CDCl₃): δ (ppm) −4262 (s).

IR (KBr) [cm⁻¹]: ν⁻¹ 3480 (s), 2950 (vw), 2923 (s), 2856 (s), 1699 (vs), 1503 (s), 1477 (s), 1463 (s), 1424 (vw), 1374 (s), 1341 (s), 1311 (m), 1237 (s), 1188 (s), 1169 (s), 1096 (m), 1039 (s), 1004 (m), 968 (s), 934 (m), 918 (s), 893 (s), 873 (m), 851 (s), 828 (m), 799 (s), 756 (s), 723 (m), 694 (vs), 619 (s), 561 (m), 465 (m).

MS (70 eV, EI), m/z (%): 616/614/613/612 (12/53/64/54) [M⁺], 487/486/485 (20/24/25) [M⁺−I], 359/358/357/356/355 (70/82/100/43/55) [C₁₂H₂₀Pt⁺], 164 (26) [C₁₂H₂₀⁺].

HRMS (C₁₂H₂₀PtI₂): calc. 612.9303; found 612.9304.

### Example 24

### η⁴-((1E,5Z)-1-n-Butylcycloocta-1,5-diene)dimethylplatinum [PtMe₂(nBu-COD)]

The compound was prepared according to the general procedure for the synthesis of platinum complexes of Example 5.

218 mg (1.00 eq., 0.553 mmol) Pt(acac)₂ and 100 mg (1.10 eq., 0.609 mmol) (1E,5Z)-1-n-butylcycloocta-1,5-diene were dissolved in toluene (21 mL) and 0.834 mL (2 M in toluene, 3.00 eq., 1.66 mmol). AlMe₃ was added dropwise. The reaction mixture was worked up after 24 hours. 174 mg (0.446 mmol, 81%) of the desired product was obtained as colorless oil.

¹H-NMR (400 MHz, CDCl₃): δ (ppm) 0.69 (s d, ²J_{PtH}=81.5 Hz, 6H, CH₃), 0.89 (d, ³J=7.2 Hz, 3H, CH₃), 1.19-1.38 (m, 3H, CH₂), 1.56-1.62 (m, 1H, CH₂), 1.84-1.99 (m, 1H, CH₂), 2.03-2.18 (m, 3H, CH₂), 2.20-2.26 (m, 2H, CH₂), 2.29-2.52 (m, 4H, CH₂), 4.64-4.80 (m, 3H, CH).

¹³C-NMR (100 MHz, CDCl₃): δ (ppm) 3.5 (+, PtCH₃), 9.5 (+, PtCH₃), 14.0 (+, CH₃CH₂), 22.7 (−, CH₂), 28.3 (−, CH₂), 30.9 (−, CH₂), 31.0 (−, CH₂), 31.5 (−, CH₂), 33.1 (−, CH₂), 40.2 (−, CH₂), 97.5 (+, s d, ¹J_{PtC}=58.3 Hz, CH), 97.8 (+, s d, ¹J_{PtC}=61.5 Hz, CH), 99.3 (+, s d, ¹J_{PtC}=46.1 Hz, CH), 120.0 (C_{quart})

¹⁹⁵Pt-NMR (129 MHz, CDCl₃): δ (ppm) 3530 (s).

IR (ATR) [cm⁻¹]: ν⁻¹ 3442 (vs), 2925 (vw), 2873 (s), 2834 (vs), 2797 (vs), 1656 (vs), 1525 (vs), 1480 (vs), 1464 (vs), 1431 (s), 1378 (vs), 1340 (vs), 1315 (vs), 1216 (vs), 1195 (vs), 1167 (vs), 1104 (vs), 1103 (vs), 999 (vs), 929 (vs), 88 (vs), 790 (vs), 730 (vs), 559 (vs), 539 (s).

MS (70 eV, EI), m/z (%): 390/389/380 (3/2/2) [M⁺], 375/374/373 (14/16/14) [M⁺CH₃], 359/358/357/356/355/354/353 (32/70/66/85/100/48) [M⁺−2×CH₃].

HRMS (PtC₁₄H₂₆): calc. 389.1682; found 389.1681.

### Example 25

### Dichlorido-η⁴-((1E,5Z)-1-isobutylcycloocta-1,5-diene) platinum [PtCl₂(iBu-COD)]

The compound was prepared according to the general procedure for the synthesis of platinum complexes of Example 1. 494 mg (6.90 eq., 3.01 mmol) (1E,5Z)-1-isobutylcycloocta-1,5-diene was reacted with 181 mg (1.00 eq., 0.436 mmol) K₂PtCl₄, 2.00 mL n-PrOH, 2.90 mL H₂O and 2.48 mg (0.0300 eq., 13.1 pmol) SnCl₂ for five days. 172 mg (0.400 mmol, 91%) of the desired product was obtained as beige solid.

Decomposition temperature: >161° C.

¹H-NMR (400 MHz, CDCl₃): δ (ppm) 0.73 (d, ³J_{HH}=6.6 Hz, 3H, CH₃), 1.03 (d, ³J_{HH}=6.6 Hz, 3H, CH₃), 1.80-1.87 (m, 1H, CH), 2.00-2.08 (m, 2H, CH₂), 2.26-2.51 (m, 5H, CH₂), 2.56-2.63 (m, 1H, CH₂), 2.72-2.82 (m, 2H, CH₂), 5.49-5.63 (m, 3H, CH).

¹³C-NMR (100 MHz, CDCl₃): δ (ppm) 21.2 (+,CH₃), 23.9 (+, CH₃), 27.9 (+, CH), 29.2 (−, CH₂), 31.4 (−, CH₂), 31.6 (−, CH₂), 34.5 (−, CH₂), 50.1 (−, CH₂), 96.9 (+, CH), 97.1 (+,CH), 99.9 (+,CH), 128.0 (C_{quart}).

¹⁹⁵Pt-NMR (129 MHz, CDCl₃): δ (ppm) −3287 (s).

IR (KBr) [cm⁻¹]: ν⁻¹ 2955 (vw), 2927 (s), 2867 (s), 2349 (s), 1703 (s), 1502 (s), 1480 (s), 1462 (m), 1426 (s), 1384 (s), 1366 (s), 1343 (w), 1282 (s), 1242 (s), 1163 (s), 1108 (m), 1010 (m), 947 (s), 901 (s), 862 (w), 806 (s), 754 (s), 671 (s), 665 (s), 629 (m), 596 (s), 528 (s), 470 (m), 406 (s).

MS (70 eV, EI), m/z (%): 431/430/429/428 (1/1/1/1) [M⁺], 396/395/394/393/392 (17/17/42/40/34) [M⁺−Cl], 358/357/356/355/354 (53/61/100/72/79) [M⁺−2×Cl], 79 (12), 68 (4), 41 (19).

HRMS (C₁₂H₂₀Cl₂Pt): calc. 429.0590; found 429.0587.

### Example 26

### Diiodido-η⁴-((1E,5Z)-1-isobutylcycloocta-1,5-diene) platinum [PtI₂(iBu-COD)]

The compound was prepared according to the general procedure for the synthesis of platinum complexes of Example 2. 85.4 mg (1.00 eq., 0.198 mmol) [PCl₂(iBu-COD)] and 64.0 mg (2.15 eq., 0.427 mmol) NaI in 3.5 mL acetone were stirred together for three hours. 116 mg (0.189 mmol, 96%) of the desired product was obtained as an orange wax.

¹H-NMR (400 MHz, CDCl₃): δ (ppm) 0.78 (d, ³J_{HH}=6.6 Hz, 3H, CH₃), 1.01 (d, ³J_{HH}=6.6 Hz, 3H, CH₃), 1.74-1.89 (m, 3H, CH₂), 1.96-2.05 (m, 1H, CH), 2.17-2.23 (m, 1H, CH₂), 2.24-2.53 (m, 3H, CH₂), 2.58-2.76(m, 3H, CH₂), 5.57-5.92 (m, 3H, CH).

¹³C-NMR (100 MHz, CDCl₃): δ (ppm) 21.3 (+, CH₃), 23.9 (+, CH₃), 28.5 (−, CH₂), 29.6 (−, CH₂), 31.8 (−, CH₂), 32.5 (−, CH₂), 33.3 (−, CH₂), 53.1 (+, CH), 98.3 (+, CH), 100.0 (+, CH), 101.0 (+, CH), 133.6 (C_{quart}).

¹⁹⁵Pt-NMR (129 MHz, CDCl₃): δ (ppm) −4225 (s).

IR (KBr) [cm⁻¹]: ν⁻¹ 3855 (s), 3650 (s), 2954 (vw), 2349 (s), 1654 (s), 1506 (s), 1458 (s), 1428 (vw), 1383 (s), 1311 (m), 1164 (s), 1105 (m), 1008 (s), 947 (s), 895 (s), 867 (s), 801 (m), 740 (s), 671 (s), 665 (s), 622 (m), 460 (m).

MS (70 eV, EI), m/z (%): 616/614/613/612 (14/60/74/65) [M⁺], 487/486/485/484/483 (31/35/45/25/21) [M⁺−I], 359/358/357/356/355 (35/42/70/49/64) [C₁₂H₂₀Pt⁺], 164 (39) [C₁₂H₂₀⁺], 121 (72), 107 (99), 93 (67), 79 (100), 67 (82), 41 (56). HRMS (C₁₂H₂₀PtI₂): calc. 612.9303; found 612.9299.

### Example 27

### η⁴-((1E,5Z)-1-Isobutylcycloocta-1,5-diene)dimethylplatinum [PtMe₂(iBu-COD)]

The compound was prepared according to the general procedure for the synthesis of platinum complexes of Example 5. 501 mg (1.00 eq., 1.27 mmol) Pt(acac)₂ and 230 mg (1.10 eq., 1.40 mmol) (1E,5Z)-1-isobutylcycloocta-1,5-diene were dissolved in toluene (45 mL) and 1.91 mL (2 M in toluene, 3.00 eq., 3.81 mmol) AlMe₃ was added dropwise. The reaction mixture was worked up after 24 hours. 386 mg (0.991 mmol, 78%) of the desired product was obtained as a colorless solid.

Melting point: 65° C.

¹H-NMR (400 MHz, CDCl₃): δ (ppm) 0.69 (s d, ²J_{PtC}=81.3 Hz, 3H, PtCH₃), 0.71(s d, ²J_{PtC}=81.6 Hz, 3H, PtCH₃), 0.74 (d, ³J_{HH}=6.1 Hz, 3H, CH₃), 0.93 (d, ³J_{HH}=6.2 Hz, 3H, CH₃), 1.62-1.73 (m, 2H, CH₂), 2.14-2.46 (m, 9H, 4×CH₂, CH), 4.62-4.75 (m, 3H, CH).

¹³C-NMR (100 MHz, CDCl₃): δ (ppm) 3.1 (+, s d, ¹J_{PtC}=694 Hz, PtCH₃), 10.2 (+, s d, ¹J_{PtC}=726 Hz, PtCH₃), 21.0 (+,CH₃CH), 23.8 (+,CH₃CH), 27.8 (−, CH₂), 29.1 (−, CH₂), 29.6 (−, CH₂), 30.2 (−, CH₂), 33.5 (−, CH₂), 49.7 (+, CH), 96.9 (+, s d, ¹J_{PtC}=55.6 Hz,CH), 98.4 (+, s d, ¹J_{PtC}=61.8 Hz,CH), 100.2 (+, s d, ¹J_{PtC}=45.6 Hz,CH), 119.2 (+, s d, ¹J_{PtC}=50.8 Hz, C_{quart})

¹⁹⁵Pt-NMR (129 MHz, CDCl₃): δ (ppm) −3519 (s).

IR (ATR) [cm⁻¹]: ν⁻¹ 3451 (s), 2925 (vw), 2873 (s), 2834 (vs), 2798 (vs), 1658 (vs), 1641 (vs), 1563 (vs), 1567 (vs), 1526 (vs), 1480 (vs), 1463 (m), 1429 (s), 1383 (s), 1365 (s), 1343 (s), 1216 (vs), 1195 (vs), 1167 (s), 1110 (s), 998 (vs), 923 (s), 883 (vs), 863 (vs), 782 (vs), 735 (vs), 559 (vs), 540 (s).

MS (70 eV, EI), m/z (%): 390/389/377 (4/5/4) [M⁺], 375/374/373 (14/22/19) [M⁺−CH₃], 359/358/357/356/355/354 (53/33/100/68/65/47) [M⁺−2×CH₃].

HRMS (PtC₁₄H₂₆): calc. 389.1682; found 389.1681.

### Example 28

### Dichlorido-η⁴-((1E,5Z)-1-n-hexylcycloocta-1,5-diene) platinum [PtCl₂(nHex-COD)]

The compound was prepared according to the general procedure for the synthesis of platinum complexes of Example 1. 538 mg (6.90 eq., 2.80 mmol) (1E,5Z)-1-n-hexylcycloocta-1,5-diene was reacted with 168 mg (1.00 eq., 0.405 mmol) K₂PtCl₄, 1.85 mL n-PrOH, 2.69 mL H₂O and 2.30 mg (0.0300 eq., 0.0122 mmol) SnCl₂ for five days. 114 mg (0.249 mmol, 62%) of the desired product was obtained as a slightly yellow solid.

Decomposition temperature: >124° C.

¹H-NMR (400 MHz, CDCl₃): δ (ppm) 0.82 (t, ³J=6.7 Hz, 3H, CH₃), 1.21-1.25 (m, 6H, CH₂), 1.39-1.45 (m, 1H, CH₂), 1.77-2.03 (m, 4H, CH₂), 2.26-2.55 (m, 5H, CH₂), 2.69-2.81 (m, 2H, CH₂), 5.35-5.57 (m, 3H, CH).

¹³C-NMR (100 MHz, CDCl₃): δ (ppm) 14.0 (+, CH₃), 22.5 (−, CH₂), 28.2 (−, CH₂), 28.4 (−, CH₂), 29.2 (−, CH₂), 31.4 (−, CH₂), 32.5 (−, CH₂), 32.7 (−, CH₂), 34.3 (−, CH₂), 41.6 (−, CH₂), 96.6 (+, CH), 98.1 (+, CH), 99.2 (+, CH), 127.9 (C_{quart}).

¹⁹⁵Pt-NMR (129 MHz, CDCl₃): δ (ppm) −3306 (s).

IR (KBr) [cm⁻¹]: ν⁻¹ 3014 (vs), 2954 (s), 2924 (vw), 2855 (s), 1504 (s), 1458 (s), 1429 (w), 1377 (vs), 1343 (s), 1316 (m), 1248 (s), 1195 (vs), 1174 (s), 1101 (s), 1045 (vs), 1012 (m), 961 (vs), 908 (s), 867 (m), 833 (s), 804 (s), 724 (s), 628 (m), 531 (s), 571 (m).

MS (70 eV, EI), m/z (%): 424/423/422/421/420 (3/3/9/7/7) [M⁺−Cl], 386/385/384/383/382(28/36/40/18/20) [M⁺−2×Cl], 192 (79) [C₁₄H₂₄⁺], 121 (92), 107 (98) [C₈H₁₁⁺], 79 (100).

HRMS (M⁺−Cl, C₁₄H₂₄ClPt): calc. 422.1215; found 422.1213.

### Example 29

### Diiodido-η⁴-((1E,5Z)-1-n-hexylcycloocta-1,5-diene) platinum [PtI₂(nHex-COD)]

The compound was prepared according to the general procedure for the synthesis of platinum complexes of Example 2. 53.6 mg (1.00 eq., 0.117 mmol) [PCl₂(nHex-COD)] and 37.7 mg (2.15 eq., 0.251 mmol) NaI in 3 mL acetone were stirred together for three hours. 59.7 mg (0.0931 mmol, 80%) of the desired product was obtained as an orange wax.

¹H-NMR (400 MHz, CDCl₃): δ (ppm) 0.81 (t, ³J_{HH}=6.8 Hz, 3H, CH₃), 1.19-1.29 (m, 6H, CH₂), 1.35-1.44 (m, 1H, CH₂), 1.67-2.08 (m, 6H, CH₂), 2.10-2.20 (m, 1H, CH₂), 2.33-2.39 (m, 1H, CH₂), 2.48-2.73 (m, 3H, CH₂), 5.46-5.95 (m, 3H, CH). ¹³C-NMR (100 MHz, CDCl₃): δ (ppm) 14.0 (+, CH₃), 22.6 (−, CH₂), 27.8 (−, CH₂), 28.7 (−, CH₂), 29.0 (−, CH₂), 31.4 (−, CH₂), 32.4 (−, CH₂), 32.8 (−, CH₂), 34.9 (−, CH₂), 44.1 (−, CH₂), 99.3 (+, CH), 99.4 (+,CH), 100.7 (+,CH), 133.4 (C_{quart}).

¹⁹⁵Pt-NMR (129 MHz, CDCl₃): δ (ppm) −4261 (s).

IR (KBr) [cm⁻¹]: ν⁻¹ 3491 (vs), 2952 (s), 2921 (vw), 2852 (s), 1711 (s), 1506 (s), 1454 (s), 1422 (w), 1376 (vs), 1343 (s), 1313 (s), 1237 (s), 1190 (vs), 1168 (s), 1089 (s), 1005 (s), 943 (vs), 864 (s), 827 (s), 801 (m), 723 (m), 622 (m), 585 (vs), 523 (s), 457 (m). MS (70 eV, EI), m/z (%): 642/641/640(39/53/46) [M⁺], 515/514/513(11/15/14) [M⁺−I], 387/386/385/384/383 (73/85/100/44/49) [C₁₄H₂₄Pt⁺], 192 (29) [C₁₄H₂₄⁺].

HRMS (C₁₄H₂₄PtI₂): calc. 640.9616; found 640.9614.

### Example 30

### η⁴-((1E,5Z)-1-n-Hexylcycloocta-1,5-diene)dimethylplatinum [PtMe₂(nHex-COD)]

The compound was prepared according to the general procedure for the synthesis of platinum complexes of Example 5. 186 mg (1.00 eq., 0.473 mmol) Pt(acac)₂ and 100 mg (1.10 eq., 0.520 mmol) (1E,5Z)-1-n-butylcycloocta-1,5-diene were dissolved in toluene (18 mL) and 0.712 mL (2 M in toluene, 3.00 eq., 1.42 mmol) AlMe₃ was added dropwise. The reaction mixture was worked up after 24 hours. 172 mg (0.412 mmol, 87%) of the desired product could be obtained as a colorless oil.

¹H-NMR (400 MHz, CDCl₃): δ (ppm) 0.69 (s d, ²J_{PtH}=81.6 Hz, 6H, CH₃), 0.88 (t, ³J=6.6 Hz, 3H, CH₃), 1.21-1.33 (m, 8H, CH₂), 1.56-1.63 (m, 1H, CH₂), 1.85-1.96 (m, 1H, CH₂), 2.04-2.17 (m, 3H, CH₂), 2.21-2.29 (m, 2H, CH₂), 2.36-2.53 (m, 3H, CH₂), 4.65-4.75 (m, 3H, CH). ¹³C-NMR (100 MHz, CDCl₃): δ (ppm) 3.5 (+, s d, ¹J_{PtC}=765 Hz, PtCH₃), 9.5 (+,s d, ¹J_{PtC}=778 Hz, PtCH₃), 14.1 (+, CH₃CH₂), 22.6 (−, CH₂), 28.3 (−, CH₂), 29.2 (−, CH₂), 29.3 (−, CH₂), 30.9 (−, CH₂), 31.0 (−, CH₂), 31.7 (−, CH₂), 33.1 (−, CH₂), 40.5 (−, CH₂), 97.5 (+, s d, ¹J_{PtC}=55.6 Hz,CH), 97.8 (+, s d, ¹J_{PtC}=59.7 Hz,CH), 99.3 (+, s d, ¹J_{PtC}=46.2 Hz,CH), 119.8 (s d, ¹J_{PtC}=55.7 Hz, C_{quart}).

¹⁹⁵Pt-NMR (129 MHz, CDCl₃): δ (ppm) 3527 (s).

IR (ATR) [cm⁻¹]: ν⁻¹ 3443 (vs), 2924 (vw), 2873 (s), 2798 (vs), 1658 (vs), 1525 (vs), 1480 (vs), 1464 (s), 1432 (vs), 1378 (vs), 1340 (vs), 1315 (vs), 1217 (s), 1197 (vs), 1168 (vs), 1107 (s), 1000 (vs), 866 (s), 788 (vs), 725 (vs), 560 (vs), 540 (s). MS (70 eV, EI), m/z (%):417 (1) [M⁺], 403/402/401 (22/26/21) [M⁺−CH₃], 389/388/387/386/385/384/383/382/381 (8/9/47/62/100/77/70/21/23) [M⁺2×CH₃], 79 (6), 43 (9).

HRMS (PtC₁₆H₃₀): calc. 417.1996; found 417.1997.

### Example 31

### Preparation of Pt/Pd/SiO₂-Particles by combination of CVS and MOCVD

The experimental set-up is shown in FIG. 1.

a) Chemical vapor synthesis (CVS) of sub-micrometer-sized SiO₂ support particles

In a first step, aerosols of nanometer-sized silica support particles (SiO₂-Particles) were synthesized by decomposition of tetraethyl orthosilicate (TEOS) vapor (c(TEOS)=4.1×10⁻⁵ mol L⁻¹ in a stream of nitrogen gas (300 mL min⁻¹, nominally 99.99%). The nitrogen is first saturated with TEOS vapor in a temperature-controlled bubbling system (6) at 60° C. The gas/vapor mixture is diluted with air (10) (4 L min⁻¹), and then fed to a CVS Reactor (1) (Carbolite CTF 12/600; ID 12 mm, heated length 600 mm) at 1000° C., where the TEOS decomposes and nucleates to oxide particles. This aerosol is sintered in a sintering tube furnace (2) (Carbolite STF 15/ 450; ID 25 mm, heated length 450 mm) at 1500° C. to obtain spherical aerosol particles with average Feret diameter of about 80 nm. These sintered spheres provide well-defined surfaces for subsequent TEM image analysis of the coating results. The carrier particle number concentration was 10⁷ cm ⁻³ at a total flow rate of 300 mL min⁻¹. The aerosol is finally dried in a diffusion dryer (9) to remove water vapor and then fed to the MOCVD process.

b) Pd dots deposition onto the sub-micrometer-sized SiO₂ support particles by metal organic chemical vapor deposition (MOCVD)

Cp(allyl)Pd [(η³-allyl)(η⁵-cyclopentadienyl)palladiuml, a solid precursor, was stored at −23° C. under argon in a closed flask. For the deposition of Pd dots onto the SiO₂ support particles the precursor was inserted in a glove-box containing a microbalance. Under argon atmosphere 10-12 mg of the precursor was weighed into an Al₂O₃ pan and transferred afterwards in a closed vessel to a precursor sublimator (5). The Cp(allyl)Pd onto the pan is vaporized into a flow of nitrogen (150 ml/min) in the precursor sublimator for the first metal (5) at 35-50° C. The precursor vapor is transferred through a first heated transfer pipe (7) and then mixed with carrier particle aerosol and fed to the coating reactor for the first metal (3) at a temperature of 80° C. The coating reactor (double walled reactor) was made of glass with an inner diameter of 45 mm and a length of 300 mm Precursor losses were minimized by heating the coating reactor walls to 50° C. The Pd/SiO₂ particles in the resulting Pd/SiO₂ aerosol are transferred to the coating reactor for the second metal (13).

c) Pt deposition onto Pd dots of the sub-micrometer-sized SiO₂ support particles by metal organic chemical vapor deposition (MOCVD)

η⁴-((1Z,5Z)-1-ethylcycloocta-1,5-dien)dimethyl platinum [(1-ethyl-COD)PtMe₂], a solid precursor, was stored at −23° C. under argon in a closed flask. For the deposition of Pt dots onto the palladium dots of the Pd/SiO₂ particles the precursor was inserted in a glove-box containing a microbalance. Under argon atmosphere 10-12 mg of the precursor was weighed into an Al₂O₃ pan and transferred afterwards in a closed vessel to a precursor sublimator for the second metal (11). The (1-ethyl-COD)PtMe₂ onto the pan is vaporized into a flow of nitrogen (150 ml/min) in the precursor sublimator for the second metal (11) at 100° C. The precursor vapor is transferred through a second heated transfer pipe (12) and then mixed with carrier particle aerosol and fed to the coating reactor for the second metal (13) at a temperature of 380° C. The coating reactor (double walled reactor) was made of glass with an inner diameter of 45 mm and a length of 300 mm Precursor losses were minimized by heating the coating reactor walls to 100° C. The Pt/Pd/SiO₂ particles (particles containing multi-layered dots on the surface wherein the inner layer of the multi-layered dot consist of palladium as a first metal and the outer layer consist of platinum as a second metal) in the resulting Pt/Pd/SiO₂ aerosol (4) are collected on a membrane, a TEM grid or can be analyzed via online measuring methods after they pass the coating reactor for the second metal (13). Experiments using dichlorido-η⁴-(1Z,5Z)-1-methylcycloocta-1,5-dien) platinum, diiodido-η⁴-((1Z,5Z)-1-methylcycloocta-1,5-dien) platinum, dimethyl-η⁴-((1Z,5Z)-1-methylcycloocta-1,5-dien) platinum, η⁴-((1Z,5Z)-1-methylcycloocta-1,5-dien)diphenyl platinum, dichlorido-η⁴-(1Z,5Z)-1-ethylcycloocta-1,5-dien) platinum, η⁴-((1Z,5Z)-1-ethylcycloocta-1,5-dien)diiodido platinum, η⁴-((1Z,5Z)-1-ethylcycloocta-1,5-dien)diphenyl platinum, dichlorido-η⁴-((1E,5Z)-1-phenylcycloocta-1,5-dien) platinum, diiodido-η⁴-((1E,5Z)-1-phenylcycloocta-1,5-dien)platinum, dimethyl-η⁴-((1E,5Z)-1-phenylcycloocta-1,5-dien) platinum, diphenyl-η⁴-((1E,5Z)-1-phenylcycloocta-1,5-dien) platinum, dichlorido-η⁴-((1E,5Z)-1-isopropylcycloocta-1,5-dien) platinum, diodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-n-butylcycloocta-1,5-dien) platinum, diiodido-η⁴-((1E,5Z)-n-butylcycloocta-1,5-dien)platinum, dimethyl-η⁴-((1E,5Z)-n-butylcycloocta-1,5-dien) platinum, diphenyl-η⁴-((1E,5Z)-n-butylcycloocta-1,5-dien) platinum, dichlorido-η⁴-((1E,5Z)-iso-butylcycloocta-1,5-dien) platinum, diiodido-η⁴-((1E,5Z)-iso-butylcycloocta-1,5-dien) platinum, dimethyl-η⁴-((1E,5Z)-iso-butylcycloocta-1,5-dien) platinum, and diphenyl-η⁴-((1E,5Z)-iso-butylcycloocta-1,5-dien) platinum as precursor for the second metal show similar results.

### Example 32

### Preparation of Pt/Pd/SiO₂-Particles by MOCVD

The experimental set-up is shown in FIG. 2.

Pt deposition onto sub-micrometer-sized SiO₂ support particles containing Pd dots on its surface by metal organic chemical vapor deposition (MOCVD) (1-ethyl-COD)PtMe₂, a solid precursor, was stored at -23° C. under argon in a closed flask.

For the deposition of Pt dots onto the SiO₂ support particles the precursor was inserted into a glove-box containing a microbalance. Under argon atmosphere 10-12 mg of the precursor was weighed into an Al₂O₃ pan and transferred afterwards in a closed vessel to a precursor sublimator for the second metal (13). The (1-ethyl-COD)PtMe₂ in the pan is vaporized into a flow of nitrogen (150 ml/min) in the precursor sublimator for the second metal (13) at 100° C. The precursor vapor is transferred through a second heated transfer pipe (12) and then mixed with a carrier particle (300 mL min⁻¹; N₂ and Pd/SiO₂ particles (SiO₂ containing palladium dots on its surface) with a average Feret diameter of 70 nm) aerosol (8) and fed to the coating reactor for the second metal (13) at a temperature of 380° C. The coating reactor (double walled reactor) was made of glass with an inner diameter of 45 mm and a length of 300 mm Precursor losses were minimized by heating the coating reactor walls to 100° C. The Pt/Pd/SiO₂ particles (particles containing multi-layered dots on the surface wherein the inner layer of the multi-layered dot consist of palladium as a first metal and the outer layer consist of platinum as a second metal) in the resulting Pt/Pd/SiO₂ aerosol (4) are collected on a membrane, a TEM grid or can by analyzed via online measuring methods after they pass the coating reactor (3).

Experiments using dichlorido-η⁴-(1Z,5Z)-1-methylcycloocta-1,5-dien) platinum, diiodido-η⁴-((1Z,5Z)-1-methylcycloocta-1,5-dien) platinum, dimethyl-η⁴-((1Z,5Z)-1-methylcycloocta-1,5-dien) platinum, η⁴-((1Z,5Z)-1-methylcycloocta-1,5-dien)diphenyl platinum, dichlorido-η⁴-(1Z,5Z)-1-ethylcycloocta-1,5-dien) platinum, η⁴-((1Z,5Z)-1-ethylcycloocta-1,5-dien)diiodido platinum, η⁴-((1Z,5Z)-1-ethylcycloocta-1,5-dien)diphenyl platinum, dichlorido-η⁴-((1E,5Z)-1-phenylcycloocta-1,5-dien) platinum, diiodido-η⁴-((1E,5Z)-1-phenylcycloocta-1,5-dien) platinum, dimethyl-η⁴-((1E,5Z)-1-phenylcycloocta-1,5-dien) platinum, diphenyl-η⁴-((1E,5Z)-1-phenylcycloocta-1,5-dien) platinum, dichlorido-η⁴-((1E,5Z)-1-isopropylcycloocta-1,5-dien) platinum, diodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-n-butylcycloocta-1,5-dien) platinum, diiodido-η⁴-((1E,5Z)-n-butylcycloocta-1,5-dien) platinum, dimethyl-η⁴-((1E,5Z)-n-butylcycloocta-1,5-dien) platinum, diphenyl-η⁴-((1E,5Z)-n-butylcycloocta-1,5-dien) platinum, dichlorido-η⁴-((1E,5Z)-iso-butylcycloocta-1,5-dien) platinum, diiodido-η⁴-((1E,5Z)-iso-butylcycloocta-1,5-dien) platinum, dimethyl-η⁴-((1E,5Z)-iso-butylcycloocta-1,5-dien) platinum, and diphenyl-η⁴-((1E,5Z)-iso-butylcycloocta-1,5-dien) platinum as precursor show similar results.

### Example 33

### Pt/Pd/SiO₂-Particles

An aerosol of nanometer-sized silica support particles containing palladium dots (Pd/SiO₂-Particles; substrate) were synthesized according to the process described in Example 31. Precursor vapor for MOCVD is prepared according to the process described in Example 31. The experimental set-up is shown in FIG. 3.

Alternative a)

The synthesized nanometer-sized silica support particles containing palladium dots (Pd/SiO₂-Particles; substrate) are fluidized in a fluidized bed reactor (14) and the vaporized metal organic precursor is subsequently transferred through a heated transfer pipe (7) to the fluidized bed reactor (14).

For this (1-ethyl-COD)PtMe₂, a solid precursor, was stored at −23° C. under argon in a closed flask. For the deposition of Pt dots onto the Pd/SiO₂ support particles the precursor was inserted into a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ in the boat is vaporized into a flow of nitrogen (150 ml/min) in the precursor sublimator (5) at 100° C.

The fluidized bed reactor (14) had an inner diameter of 70 mm and a height of 800 cm and was electrically heated. The reaction temperature can be varied in the range of 50 to 500° C. The main fluidization flow entered the reactor through a glass frit at the bottom end and was varied between 2 and 20 l/min Fluidization requires the break-up of large agglomerates, which can be achieved by vibration, a small (0.2-1 l/min) but high velocity (10-100 m/s) gas flow produced by a small orifice (200-600 μm) mounted to a lance (15) which is inserted into the particle bed, or other measures. Intensive intermixing of the fluidized particles ensures a uniform distribution of the vaporized metal organic precursor in the fluidized bed reactor (14) and a uniform distribution of vaporized metal organic precursor on the surface of the particles through adsorption.

Preconditioning of particles by adjustment of the OH-group concentration and the addition of reactive gases such as oxygen or hydrogen (1-5% by Volume) lead to a decomposition of the precursors on the palladium dots, so as to form two-layered dots (comprising a palladium innermost layer and a platinum outermost layer) in a single step. The crucial parameters for product control (i.e. for controlling structure and shape of product particles comprising two-layered dots on silica support particles, for controlling the size distribution and number of two-layered dots on the particle surfaces, etc.) are the concentration of the platinum precursor (1-100 ppm), the coating duration (2-60 min), the reaction temperature (50-500° C.), the OH-group concentration of the particle surface (2-15 groups/nm²), and the amount of the palladium dots on the particle at the beginning. The concentration of OH groups on the surface can be adjusted by treating the particles in a fluidized bed reactor with water vapor or dry inert gases. For a reduction of the OH group concentration heating in inert gases at 300-500° C. for 10-60 min was carried out. To increase the OH-group concentration, treatment of the oxide powders in water vapor (1-5% by Volume) at temperatures ranging from 200-500° C. was carried out. The determination of OH-group concentration can be done by thermogravimetric analysis, Si-NMR, H-NMR or by titration.

The palladium dot on the silica support forms the innermost layer of the multi-layered dot, and the platinum that is deposited on the palladium dots forms the outermost layer of the multi-layered dot.

Experiments using dichlorido-η⁴-(1Z,5Z)-1-methylcycloocta-1,5-dien) platinum, diiodido-η⁴-((1Z,5Z)-1-methylcycloocta-1,5-dien) platinum, dimethyl-η⁴-((1Z,5Z)-1-methylcycloocta-1,5-dien) platinum, η⁴-((1Z,5Z)-1-methylcycloocta-1,5-dien)diphenyl platinum, dichlorido-η⁴-((1Z,5Z)-1-ethylcycloocta-1,5-dien) platinum, η⁴-((1Z,5Z)-1-ethylcycloocta-1,5-dien)diiodido platinum, η⁴-((1Z,5Z)-1-ethylcycloocta-1,5-dien)dimethyl platinum, η⁴-((1Z,5Z)-1-ethylcycloocta-1,5-dien)diphenyl platinum, dichlorido-η⁴-((1E,5Z)-1-phenylcycloocta-1,5-dien) platinum, diiodido-η⁴-((1E,5Z)-1-phenylcycloocta-1,5-dien) platinum, dimethyl-η⁴-((1E,5Z)-1-phenylcycloocta-1,5-dien) platinum, diphenyl-η⁴-((1E,5Z)-1-phenylcycloocta-1,5-dien) platinum, dichlorido-η⁴-((1E,5Z)-1-isopropylcycloocta-1,5-dien) platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien) platinum, diiodido-η⁴-((1E,5Z)-1-n-butylcycloocta-1,5-dien) platinum, dimethyl-η⁴-((1E,5Z)-1-n-butylcycloocta-1,5-dien) platinum, diphenyl-η⁴-((1E,5Z)-1-n-butylcycloocta-1,5-dien) platinum, dichlorido-η⁴-((1E,5Z)-1-iso-butylcycloocta-1,5-dien) platinum, diiodido-η⁴-((1E,5Z)-1-iso-butylcycloocta-1,5-dien) platinum, dimethyl-η⁴-((1E,5Z)-1-iso-butylcycloocta-1,5-dien) platinum, diphenyl-η⁴-((1E,5Z)-1-iso-butylcycloocta-1,5-dien) platinum, dichlorido-η⁴-((1E,5Z)-1-n-hexylcycloocta-1,5-diene) platinum, diiodido-η₄-((1E,5Z)-1-n-hexylcycloocta-1,5-diene) platinum, and η⁴-((1E,5Z)-1-n-hexylcycloocta-1,5-diene)dimethylplatinum as precursor show similar results.

Alternative b)

In a variation of alternative a) the CVD process is carried out in two steps. The absorption of the vaporized metal organic precursor is carried out in a first step and the decomposition reaction is carried out in a second step.

In the first step the synthesized synthesized nanometer-sized silica support particles containing palladium dots (Pd/SiO₂-Particles; substrate) are fluidized in a fluidized bed reactor (14) and the vaporized metal organic precursor is subsequently transferred through a heated transfer pipe (7) into the fluidized bed reactor (14). For this (1-ethyl-COD)PtMe₂, a solid precursor, was stored at −23° C. under argon in a closed flask. The precursor was inserted into a glove-box containing a microbalance. Under argon atmosphere 10-12 mg of the precursor was weighed into an Al₂O₃ boat and transferred afterwards in a closed vessel to a precursor sublimator (5). The (1-ethyl-COD)PtMe₂ in the boat is vaporized into a flow of nitrogen (150 ml/min) in the precursor sublimator (5) at 100° C.

The fluidized bed reactor (14) had an inner diameter of 70 mm and a height of 800 cm and was electrically heated. The reaction temperature can be varied in the range of 50 to 500° C. The main fluidization flow entered the reactor through a glass frit at the bottom end and was varied between 2 and 20 l/min Fluidization requires the break-up of large agglomerates, which can be achieved by vibration, a small (0.2-1 l/min) but high velocity (10-100 m/s) gas flow produced by a small orifice (200-600 μm) mounted to a lance (15) which is inserted into the particle bed, or other measures. Intensive intermixing of the fluidized particles ensures a uniform distribution of the vaporized metal organic precursor in the fluidized bed reactor (14) and a uniform distribution of vaporized metal organic precursor on the surface of the particles through adsorption.

The absorption can be monitored with appropriate measurement methods (FTIR, GC, MS) in the effluent gas from the fluidized bed reactor (14). After saturation of the particle surfaces with the metal organic precursor, the fluidized bed reactor (14) is flushed with an inert gas to remove metal organic precursors that are not adsorbed. Afterwards a reactive gas such as water vapor (1-10% by volume in inert gas) is added to the carrier gas flow which prompts the decomposition of the metal organic precursor and initiates the formation of (three-dimensional) two-layered dots. The process in two steps allows an adsorption and a reaction under different pressure and temperature conditions, so that the surface structure can be manipulated in different ways.

The palladium dot on the silica support forms the innermost layer of the multi-layered dot and the platinum that is deposited on the palladium dots forms the outermost layer of the multi-layered dot.

Experiments using dichlorido-η⁴-(1Z,5Z)-1-methylcycloocta-1,5-dien) platinum, diiodido-η⁴-((1Z,5Z)-1-methylcycloocta-1,5-dien) platinum, dimethyl-η⁴-((1Z,5Z)-1-methylcycloocta-1,5-dien) platinum, η⁴-((1Z,5Z)-1-methylcycloocta-1,5-dien)diphenyl platinum, dichlorido-η⁴-((1Z,5Z)-1-ethylcycloocta-1,5-dien) platinum, η⁴-((1Z,5Z)-1-ethylcycloocta-1,5-dien)diiodido platinum, η⁴-((1Z,5Z)-1-ethylcycloocta-1,5-dien)dimethyl platinum, η⁴-((1Z,5Z)-1-ethylcycloocta-1,5-dien)diphenyl platinum, dichlorido-η⁴-((1E,5Z)-1-phenylcycloocta-1,5-dien) platinum, diiodido-η⁴-((1E,5Z)-1-phenylcycloocta-1,5-dien) platinum, dimethyl-η⁴-((1E,5Z)-1-phenylcycloocta-1,5-dien) platinum, diphenyl-η⁴-((1E,5Z)-1-phenylcycloocta-1,5-dien) platinum, dichlorido-η⁴-((1E,5Z)-1-isopropylcycloocta-1,5-dien) platinum, diiodido-η⁴-((1E,5Z)-1-Isopropylcycloocta-1,5-dien) platinum, η⁴-((1E,5Z)-1-isopropylcycloocta-1,5-dien)dimethyl platinum, η⁴-((1Z,5Z)-1-isopropylcycloocta-1,5-dien)diphenyl platinum, dichlorido-η⁴-((1E,5Z)-1-n-butylcycloocta-1,5-dien) platinum, diiodido-η⁴-((1E,5Z)-1-n-butylcycloocta-1,5-dien) platinum, dimethyl-η⁴-((1E,5Z)-1-n-butylcycloocta-1,5-dien) platinum, diphenyl-η⁴-((1E,5Z)-1-n-butylcycloocta-1,5-dien) platinum, dichlorido-η⁴-((1E,5Z)-1-iso-butylcycloocta-1,5-dien) platinum, diiodido-η⁴-((1E,5Z)-1-iso-butylcycloocta-1,5-dien) platinum, dimethyl-η⁴-((1E,5Z)-1-iso-butylcycloocta-1,5-dien) platinum, diphenyl-η⁴-((1E,5Z)-1-iso-butylcycloocta-1,5-dien) platinum, dichlorido-η⁴-((1E,5Z)-1-n-hexylcycloocta-1,5-diene) platinum, diiodido-η⁴-((1E,5Z)-1-n-hexylcycloocta-1,5-diene) platinum, and η⁴-((1E,5Z)-1-n-hexylcycloocta-1,5-diene)dimethylplatinum as precursor show similar results.

### Example 34

### General Procedure for the Production of Particles Containing Poly-Layered Dots on its Surface by the Polyol Method

A solution of polyvinylpyrrolidone (PVP; stabilizer) in DEG (diethylene glycol; solvent/red. agent) is prepared and pre-heated (to >80° C.), so that the alcohol's reduction potential exceeds the necessary value for both precursor salts (one salt for the first metal and one salt for the second metal). To this, a solution of the first metal precursor is added slowly. The mixture is stirred at reaction temperature for a sufficient post-reaction period (2 h). Then a solution of the second metal precursor is added in the same way. Again, the mixture is stirred at reaction temperature for a sufficient post-reaction period (2 h). After cooling to r.t. the support particles are added. Stirring and subsequent drying of the suspension leads to a deposition of the metal dots on the support particles.

What is claimed is:

1. A product comprising an amount of particles having one or more multi-layered dots on their surface, each multi-layered dot consisting of two or more layers and having an innermost layer contacting the surface of the particle, and an outermost layer,
wherein the innermost layer of the multi-layered dots consists of a first metal and the outermost layer of the multi-layered dots consists of a second metal, different from the first metal.

2. The product according to claim 1, wherein the particles having one or more multi-layered dots on their surface without consideration of the multi-layered dots have a mean Feret diameter in the range of from 12 to 300 nm.

3. The product according to claim 1, wherein the multi-layered dots have a mean Feret diameter below 10 nm.

4. The product according to claim 1, wherein, in processes for depositing metal on the surface of said particles by MOCVD, the first metal has a lower tendency to form larger dots than the second metal.

5. The product according to claim 1, wherein the second metal has a higher catalytic activity than the first metal, for the reaction of ethane with oxygen to carbondioxide and water.

6. The product according to claim 1, wherein the first metal is palladium.

7. The product according to claim 1, wherein the second metal is platinum.

8. The product according to claim 1, wherein at least 90% of the multi-layered dots having a minimum diameter of 0.1 nm have a diameter in the range of from 0.5 to 4 nm.

9. The product according to claim 1, wherein the particles have at least 1 multi-layered dot per 100 nm² of the particle surface.

10. The product according to claim 1, wherein the particle comprises (a) one or more oxides selected from the group consisting of SiO₂, MgO, Al₂O₃, TlO₂, ZrO₂, Y₂O₃, Cr₂O₃, La₂O₃, Fe₂O₃, ZnO, SnO, and carbon and/or (b) one or more mixed oxides of two, three, or more oxides selected from the group consisting of SiO₂, MgO, Al₂O₃, TiO₂, ZrO₂, Y₂O₃, Cr₂O₃, La₂O₃, Fe₂O₃, ZnO, and SnO.

11. The product according to claim 10, wherein the particle having one or more multi-layered dots on its surface is obtained by a process comprising metal organic chemical vapor deposition of the outer layer on the inner layer.

12. The product according to claim 11, wherein the substrate having one or more multi-layered dots on its surface is obtained by a metal organic chemical vapor deposition process, wherein a compound of Formula (I) 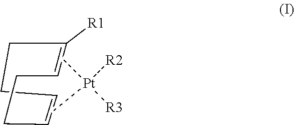
wherein R1 represents a group selected from the list consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene, and
wherein R2 and R3 independently of each other are selected from the group consisting of Cl, I, methyl, phenyl, or phenylacetylene,
is used as a precursor to form the outer layer of the multi-layered dots.

13. A method of producing the product of claim 1, the method comprising a metal organic chemical vapor deposition process using one, two, three, four, or more metal organic precursors.

14. The method according to claim 13, wherein one, two, three, four, or more of the precursors is a compound or are compounds of the general formula (I) 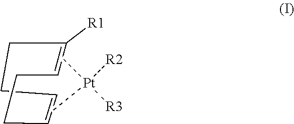
wherein R1 is selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene;
and wherein R2 and R3 independently of each other are selected from the group consisting of Cl, I, methyl, phenyl, or phenylacetylene.

15. The method according to claim 14, wherein the substituents R2 and R3 are identical and each is selected from the group consisting of Cl, I, methyl, phenyl, or phenylacetylene.

16. The method according to claim 15, wherein the compound of the general formula (I) is a compound selected from the group consisting of dichlorido-η⁴-((1Z,5Z)-1-methylcycloocta-1,5-dien)-platinum, diiodido-η⁴-((1Z,5Z)-1-methylcycloocta-1,5-dien)-platinum, dimethyl-η⁴-((1Z,5Z)-1-methylcycloocta-1,5-dien)-platinum, η⁴-((1Z,5Z)-1-methylcycloocta-1,5-dien)diphenyl platinum, dichlorido-η⁴-((1Z,5Z)-1-ethylcycloocta-1,5-dien)platinum, η⁴-((1Z,5Z)-1-ethylcycloocta-1,5-dien)diiodido platinum, η⁴-((1Z,5Z)-1-ethylcycloocta-1,5-dien)dimethyl platinum, η⁴-((1Z,5Z)-1-ethylcycloocta-1,5-dien)diphenyl platinum, dichlorido-η⁴-((1E,5Z)-1-phenylcycloocta-1,5-dien) platinum, diiodido-η⁴-((1E,5Z)-1-phenylcycloocta-1,5-dien) platinum, dimethyl-η⁴-((1E,5Z)-1-phenylcycloocta-1,5-dien) platinum, diphenyl-η⁴-((1E,5Z)-1-phenylcycloocta-1,5-dien) platinum, dichlorido-η⁴-((1E,5Z)-1-isopropylcycloocta-1,5-dien) platinum, diodido-η⁴-((1E,5Z)-1-Isopropylcycloocta-1,5-dien) platinum, η⁴-((1E,5Z)-1-isopropylcycloocta-1,5-dien)dimethyl platinum, and η⁴-((1Z,5Z)-1-isopropylcycloocta-1,5-dien)diphenyl platinum.

17. The method according to claim 13, wherein one, two, three, or more of the precursors are compounds selected from the group consisting of Pd(allyl)₂, Pd (CH₂allyl)₂, Cp(allyl)Pd [(η³-allyl)(η⁵-cyclopentadienyl)palladium], and Pd(allyl)(hfac).

18. The method according to claim 13, wherein the metal organic chemical vapor deposition process is at least partly or completely performed under a pressure in the range of from 1 mbar to 2000 mbar.

19. A method for producing multi-layered dots on a substrate, the method comprising the steps
preparing or providing a substrate having one or more dots on its surface, the dots consisting of an innermost layer of a first metal and, optionally, one or more further layers of metal; and
contacting a precursor with said substrate having one or more dots, under conditions in which the precursor decomposes into a second metal, wherein the second metal is different from the first metal.

20. The method according to claim 19, wherein the second metal and the conditions for depositing the second metal on the substrate are selected so that the second metal is predominantly deposited on the dots.

21. The method according claim 19, wherein the precursor for the deposition of the second metal is a compound of formula (I) 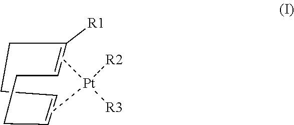
wherein R1 is selected from the group consisting of methyl, ethyl, n-propyl, isopropyl, n-butyl, sec-butyl, tert-butyl, linear or branched, saturated or mono- or polyunsaturated aliphatic carbon chain containing from two to ten carbon atoms, phenyl, and phenylacetylene;
and wherein R2 and R3 independently of each other are selected from the group consisting of Cl, I, methyl, phenyl, or phenylacetylene.

22. A catalyst system in a catalytic converter or for asymmetric hydrogenation, the catalyst system comprising the product according to claim 1.
